(19) United States
(12) Patent Application Publication
(10) Pub. No.: US 2025/0181002 A1
(43) Pub. Date: Jun. 5, 2025

(54) TONER

(71) Applicant: CANON KABUSHIKI KAISHA, Tokyo (JP)

(72) Inventors: KENJI OOKUBO, Shizuoka (JP); DAI NOZAKI, Shizuoka (JP); MASASHI UNO, Shizuoka (JP); SHOHEI KOTOTANI, Shizuoka (JP)

(21) Appl. No.: 18/959,006

(22) Filed: Nov. 25, 2024

(30) Foreign Application Priority Data
Dec. 1, 2023 (JP) 2023-203616

(51) Int. Cl. G03G 9/087; G03G 9/097

(52) U.S. Cl. CPC G03G 9/08782; G03G 9/08708; G03G 9/09725

(57) ABSTRACT

On the surface of a toner particle, a cohesion cluster containing a silica fine particle and a binding component is present. When a ratio by number of toner particles each having the cohesion cluster is denoted by CI (percent by number), the CI is 1 percent by number or more and 15 percent by number or less. When a ratio by number of toner particles each having the cohesion cluster in a toner subjected to processing under a weak ultrasound condition A is denoted by Ca (percent by number) and a ratio by number of toner particles each having the cohesion cluster in a toner subjected to processing under a strong ultrasound condition B is denoted by Cb (percent by number), the CI, the Ca, and the Cb satisfy formulae (1) and (2):

$$0.9 \leq Ca / CI \leq 1. , and \qquad ( 1 )$$

$$0.05 \leq Cb / CI \leq 0 \text{.25} . \qquad ( 2 )$$

### BACKGROUND

### Technical Field

Aspects of the present disclosure generally relate to a toner which is used for a recording method using, for example, an electrophotographic method.

### Description of the Related Art

Recently, an image forming apparatus such as a copying machine or printer has been requiring further energy saving and further life prolongation along with the advancement of diversification of the intended use and usage environment.

While the image forming method includes many known measures, the electrophotographic method is one of main techniques among them. The process of the electrophotographic method is configured as follows. First, the process forms an electrostatic latent image on an electrostatic image bearing member (hereinafter also referred to as a “photosensitive member”) by a variety of measures. Next, the process performs development of the latent image with a developer (hereinafter also referred to as “toner”) to make the latent image into a visible image (toner image), transfers the toner image to a recording medium such as paper as needed, and then fixes the toner image onto the recording medium by, for example, heat or pressure, thus obtaining a duplicate.

While energy saving can be attained as long as the fixing temperature for toner is able to be lowered, since a toner which is able to be fixed at low temperature usually decreases in hardness thereof at room temperature, the low-temperature fixability and the durability are likely to be in a relationship of trade-off. For example, in a case where an ester wax is used as a material for increasing the fusibility of toner, while the low-temperature fixability increases, toner may adhere to a member incorporated in the image forming apparatus due to a prolonged use thereof, thus causing an adverse effect on a formed image. A great number of techniques for satisfying the low-temperature fixability and the durability have previously been proposed.

For example, Japanese Patent Application Laid-Open No. 2020-197616 discusses a technique for, with regard to a member contamination about, for example, a conveyance roller occurring due to an ester wax being added as a binding resin, satisfying the low-temperature fixability and the member contamination inhibition by setting the carbon number of the ester wax and the exothermic peak measured by a differential scanning calorimetry to respective specific values.

Moreover, Japanese Patent No. 6,953,280 discusses a technique for, in a toner containing a styrene acrylic copolymer and an ester wax, satisfying the low-temperature fixability and the contamination inhibition in the image forming apparatus by setting a weight loss rate measured by a thermogravimetric analysis to within a specific range.

However, the recently required level of both a longer operating life and a high image quality being satisfied is very high, so that, even if the above-mentioned techniques are used, it is hard to say that the inhibition of a member contamination is sufficient.

### SUMMARY

Aspects of the present disclosure are generally directed to providing a toner capable of satisfying both the low-temperature fixability and the member contamination inhibition over an extended period of time even in a case where an ester wax high in compatibility is used.

According to an aspect of the present disclosure, a toner includes a toner particle, wherein the toner particle contains a binding resin and an ester wax, wherein 2.0 parts by mass or more of the ester wax is compatible with 100.0 parts by mass of the binding resin at 100° C. (degree Celsius), wherein, on a surface of the toner particle, a cohesion cluster containing a silica fine particle and a binding component is present, wherein, when a ratio by number of toner particles each having the cohesion cluster is denoted by CI (percent by number), the CI is 1 percent by number or more and 15 percent by number or less, and wherein, when a ratio by number of toner particles each having the cohesion cluster in a toner subjected to processing under the following ultrasound condition A is denoted by Ca (percent by number) and a ratio by number of toner particles each having the cohesion cluster in a toner subjected to processing under the following ultrasound condition B is denoted by Cb (percent by number), the CI, the Ca, and the Cb satisfy the following formulae (1) and (2):
ultrasound condition A: an output frequency of 30 kilohertz (kHz), an output capacity of 0.75 watt (W), and an irradiation time of 300 seconds(s), and
ultrasound condition B: an output frequency of 30 kHz, an output capacity of 30 W, and an irradiation time of 300 s,

$$0.9 \leq Ca / CI \leq 1. , and \qquad ( 1 )$$

$$0.05 \leq Cb / CI \leq 0 \text{.25} . \qquad ( 2 )$$

Further features of the present disclosure will become apparent from the following description of exemplary embodiments with reference to the attached drawings.

### BRIEF DESCRIPTION OF THE DRAWINGS

FIG. 1 is a representative diagram of a toner having a cohesion cluster.

FIG. 2 is a schematic diagram of a cross-section of the toner having a cohesion cluster.

FIG. 3 is a diagram illustrating an example of an image which is obtained by performing predetermined processing using ImageJ (a Java-based image processing program) on an analytical image obtained in a method of confirming a dispersion state of binding components contained in a cohesion cluster.

FIG. 4 is a diagram illustrating an example of an image obtained by drawing, on the image illustrated in FIG. 3, a total of 18 straight lines, as line segments, each extending from an end to an end of the image at intervals of 10° in such a way as to, with a center of the image set as a reference point, cause all of the line segments to pass through the reference point.

### DESCRIPTION OF THE EMBODIMENTS

In the present disclosure, the description of “∘∘ or more and xx or less” or “∘∘ to xx” means, unless otherwise stated, a numerical range including a lower limit and an upper limit serving as end points. Moreover, in the following description, a toner particle on the toner particle surface of which a cohesion cluster is not yet present may be referred to as a “toner core particle”.

### ASPECTS OF THE PRESENT DISCLOSURE

A toner according to an aspect of the present disclosure includes a toner particle, wherein the toner particle contains a binding resin and an ester wax, wherein 2.0 parts by mass or more of the ester wax is compatible with 100.0 parts by mass of the binding resin at 100° C. (degree Celsius), wherein, on a surface of the toner particle, a cohesion cluster containing a silica fine particle and a binding component is present, wherein, when a ratio by number of toner particles each having the cohesion cluster is denoted by CI (percent by number), the CI is 1 percent by number or more and 15 percent by number or less, and wherein, when a ratio by number of toner particles each having the cohesion cluster in a toner subjected to processing under the following ultrasound condition A is denoted by Ca (percent by number) and a ratio by number of toner particles each having the cohesion cluster in a toner subjected to processing under the following ultrasound condition B is denoted by Cb (percent by number), the CI, the Ca, and the Cb satisfy the following formulae (1) and (2):
ultrasound condition A: an output frequency of 30 kilohertz (kHz), an output capacity of 0.75 watt (W), and an irradiation time of 300 seconds(s), and
ultrasound condition B: an output frequency of 30 kHz, an output capacity of 30 W, and an irradiation time of 300 s,

$$0.9 \leq Ca / CI \leq 1. , and \qquad ( 1 )$$

$$0.05 \leq Cb / CI \leq 0 \text{.25} . \qquad ( 2 )$$

The inventors of the present disclosure have found that, with the above-described configuration employed, even in a toner excellent in low-temperature fixability using an ester wax, it is possible to prevent or reduce the occurrence of an adverse effect on a formed image due to a prolonged use. Although the details of the reason for this are not clear, the inventors estimate the reason as follows.

A cohesion cluster discussed in the present disclosure is able to maintain the state of having adhered to a toner in the case of receiving specific weak stress and to desorb from a toner in the case of receiving specific strong stress. Thus, in a toner meeting the requirements of the present disclosure, a cohesion cluster does not desorb in a normal developing process in an image forming apparatus, and, on the other hand, a cohesion cluster is able to desorb in a developing process high in stress such as to cause a toner particle to be deformed or cracked. A toner particle using an ester wax is likely to cause, when receiving high stress, deformation or cracking of the toner particle, and, in such a place, the deformed or cracked toner may adhere to a developing member. Once the toner adheres to the developing member, the adhesion of the toner escalates into a chain reaction beginning at such an adhesion place, so that an adverse effect on a formed image may be caused. However, a toner in the present disclosure is able to supply a cohesion cluster containing a silica fine particle and a binding component, in a process in which a member contamination is likely to be increasing in that manner. Particularly, since a toner is likely to crack at a portion thereof which contains a large amount of ester wax and is low in strength, an ester wax is likely to become exposed on a broken-out section of the toner. Since an ester wax is a material high in polarity and has a high affinity for silica made from a siloxane bond, in a case where a cohesion cluster has been supplied, the cohesion cluster promptly coats the above-mentioned broken-out section. It is thought that this prevents or reduces a chain-reaction adhesion of toner, thus inhibiting a member contamination. While such an effect can be promising to some extent even in the case of using a silica fine particle as an external additive, since the external additive become embedded in a toner particle along with durability, it is impossible to obtain a sufficient advantageous effect in a prolonged use.

On the other hand, since, in the present disclosure, it is possible to supply a cohesion cluster containing a silica fine particle and a binding component even in the latter half of durability, it is possible to obtain a sufficient advantageous effect even in a prolonged use.

Various exemplary embodiments, features, and aspects of the disclosure concerning compositions of a toner will be described in detail below with reference to the drawings. Furthermore, the exemplary embodiments are not limited to the contents described below.

### [Cohesion Cluster and Toner Particle]

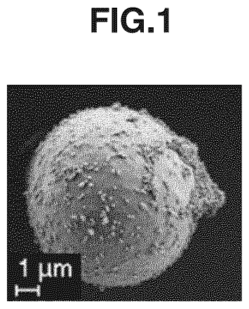

FIG. 1 is a representative diagram of a toner on the toner particle surface of which a cohesion cluster is present.

As a silica fine particle serving as a constituent of a cohesion cluster, both a dry silica fine particle, what is called a dry method or fumed silica, generated by, for example, vapor phase oxidation of a silicon halogen compound and what is called a wet silica fine particle produced from, for example, water glass can be used. Hydrophobization treatment can be performed on these particles. Examples of processing agents which are used for hydrophobization treatment include a silicone varnish, various modified silicone varnishes, a silicone oil, various modified silicone oils, a silane compound, a silane coupling agent, and the other organosilicon compounds and organotitanium compounds. These can also be used singly, or two types or more of them can be used in combination.

It is favorable that the number average particle diameter of a primary particle of the silica fine particle is 5 nanometers (nm) or more and 300 nm or less (more favorably, 10 nm or more and 200 nm or less). The number average particle diameter of a primary particle of the silica fine particle can be measured with use of a photograph of a toner obtained by performing enlargement image capturing by a scanning electron microscope.

As a binding component for binding a silica fine particle, a material which is available for adhesion of particles at appropriate strength and which does not cause an adverse effect even when receiving a mechanical stress or environment change such as temperature change or humidity change in a developing process is required. Examples of such a material include an organic resin. Particularly, a vinyl resin or a polyester resin can be used suitably. These enable holding particles composed mainly of silica at an appropriate adhesion strength and, along with the use of a toner, continuously supplying particles composed mainly of silica into a developing process. Moreover, while the binding component itself is suppled at the same time into the developing process, appropriately selecting the hardness of the binding component or a responsiveness in environment change such as temperature change or humidity change enables inhibiting a member contamination or a change in development characteristics. It is favorable that the contained amount of silica fine particles in a cohesion cluster is 50% or more and 95% or less of the entirety when the cohesion cluster is observed with a reflection electron image obtained by a scanning electron microscope. A specific material of the silica fine particle is described in paragraphs for a production method described below.

With regard to a toner in the present disclosure, it is necessary that, when the ratio by number of toner particles each having the cohesion cluster is denoted by CI (percent by number), the CI is 1 percent by number or more and 15 percent by number or less. If the CI is too low, since the number of toner particles each having the cohesion cluster is too small, an advantageous effect in the present disclosure cannot be obtained. If the CI is too high, since the number of toner particles each having the cohesion cluster is too large, a large number of cohesion clusters may remain even on a conductive member at a nip portion between a conductive roller and a photosensitive member, thus aggravating a contamination of the conductive member. It is favorable that the CI is 2 percent by number or more and 14 percent by number or less, and it is more favorable that the CI is 3 percent by number or more and 12 percent by number or less. Moreover, it is possible to control the CI by adjusting a production condition such as the number of prepared materials, the types of materials, and an agitation condition.

Additionally, with regard to the toner in the present disclosure, when a ratio by number of toner particles each having the cohesion cluster in a toner subjected to processing under the following ultrasound condition A is denoted by Ca (percent by number) and a ratio by number of toner particles each having the cohesion cluster in a toner subjected to processing under the following ultrasound condition B is denoted by Cb (percent by number), the CI, the Ca, and the Cb satisfy the following formulae (1) and (2):
ultrasonic condition A: an output frequency of 30 kilohertz (kHz), an output capacity of 0.75 watt (W), and an irradiation time of 300 seconds(s), and
ultrasonic condition B: an output frequency of 30 kHz, an output capacity of 30 W, and an irradiation time of 300 s,

$$0.9 \leq Ca / CI \leq 1. , and \qquad ( 1 )$$

$$0.05 \leq Cb / CI \leq 0 \text{.25} . \qquad ( 2 )$$

Thus, it is necessary that the range of “Ca/CI” is 0.90 or more and 1.00 or less, and “Ca/CI” being less than 0.90 means even a share in which the cohesion cluster is weak being likely to transition. Therefore, since the cohesion cluster becomes likely to be always supplied to a blocking layer (a layer, composed mainly of an external additive, which, with respect to a contact surface between a drum of the photosensitive member and a cleaning blade, stays on the opposite side in the movement direction of the drum and blocks toner particles from passing through the contact surface), the advantageous effect does not last long and the conductive member is also likely to be contaminated. The favorable range of “Ca/CI” is 0.95 or more and 1.00 or less. It is possible to control “Ca/CI” by, for example, adjusting the types of materials of a silica fine particle and a binding component or the compounding ratio between them.

It is necessary that the range of “Cb/CI” is 0.05 or more and 0.25 or less. If “Cb/CI” is larger than 0.25, since that means even a share in which the cohesion cluster is strong being unlikely to transition, an advantageous effect in the present disclosure is unlikely to be obtained. The favorable range of “CB/CI” is 0.11 or more and 0.21 or less. It is possible to control “Cb/CI” by, for example, adjusting the types of materials of a silica fine particle and a binding component or the compounding ratio between them.

Additionally, it is favorable that the arithmetic mean value Ag of Feret diameters of the cohesion cluster is 1,000 nm or more and 8,000 nm or less. If the cohesion cluster is within the above-mentioned range, since the cohesion cluster is sufficiently large, the cohesion cluster is likely to lie across between a domain and a matrix at the nip portion between the conductive member and the photosensitive member. It is more favorable that the arithmetic mean value Ag is 1,300 nm or more and 7,500 nm or less, and it is further favorable that the arithmetic mean value Ag is 1,500 nm or more and 7,000 nm or less. It is possible to control the arithmetic mean value Ag of Feret diameters of the cohesion cluster by, for example, adjusting a production condition such as the particle diameter of a silica fine particle to be used, the number of prepared parts, the compounding ratio between a silica fine particle and a binding component, and an agitation condition.

Additionally, it is favorable that, in a surface on which a toner particle having the cohesion cluster is observed by a scanning electron microscope, the area ratio of a binding component of the cohesion cluster is 5% or more and 50% or less relative to the entire cohesion cluster. As mentioned above, the cohesion cluster containing a binding component in moderation enables the transitivity of the cohesion cluster to be appropriately controlled, so that an advantageous effect in the present disclosure can be obtained at high levels. If the area ratio is smaller than the above-mentioned range, the cohesion cluster is likely to transition and is thus likely to contaminate the conductive member, so that an advantageous effect is unlikely to be obtained over a long service life. If the area ratio is larger than the above-mentioned range, the cohesion cluster is unlikely to transition, so that an advantageous effect for improving faulty cleaning is unlikely to be obtained. It is possible to control the area ratio of a binding component of the cohesion cluster by, for example, adjusting a production condition such as the compounding ratio between a silica fine particle and a binding component and an agitation condition.

Additionally, it is favorable that, from among toner particles each having the cohesion cluster, the ratio of toner particles each having a cohesion cluster satisfying the following condition (a) is 50 percent by number or more.

(a): When, in an image obtained by binarizing a reflection electron image obtained by performing image capturing of a cohesion cluster with a scanning electron microscope, 18 straight lines are drawn at intervals of 10° in such a way as to, with a center of the image obtained by performing image capturing of the cohesion cluster set as a reference point, pass through the reference point, the number A of straight lines having a line segment in which the length of a dark portion continuous on each of the straight lines is 100 nm or more is 12 or more relative to the total of 18 straight lines.

Satisfying the above-mentioned condition (a) means binding components being contained in a cohesion cluster in an evenly dispersed manner. Therefore, a variation is unlikely to occur in the transition of a cohesion cluster, so that an advantageous effect in the present disclosure is likely to be obtained. It is more favorable that the ratio of toner particles each having a cohesion cluster satisfying the above-mentioned condition (a) is 60 percent by number or more, and it is further favorable that the ratio of toner particles each having a cohesion cluster satisfying the above-mentioned condition (a) is 80 percent by number or more.

Furthermore, it is more favorable that the number A of straight lines is 13 or more relative to the total of 18 straight lines, and it is further favorable that the number A of straight lines is 15 or more.

It is possible to control the ratio of toner particles each having a cohesion cluster satisfying the above-mentioned condition (a) by, for example, adjusting a production condition such as the compounding ratio between a silica fine particle and a binding component and a dispersion condition of a silica fine particle or a binding component to be used.

[Constituent Components of Toner Particle Other than Cohesion Cluster]

### <Binding Resin>

The toner in the present disclosure contains a binding resin. The binding resin is not particularly limited, and a known resin can be used as the binding resin. Examples of the binding resin to be used include homopolymers of aromatic vinyl compounds such as polystyrene and polyvinyltoluene, and their substitutes; copolymers of aromatic vinyl compounds such as styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-dimethylaminoethyl acrylate copolymer, styrene-methyl methacrylate copolymer, styrene-ethyl methacrylate copolymer, styrene-butyl methacrylate copolymer, styrene-dimethylaminoethyl methacrylate copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-maleic acid copolymer, and styrene-maleic acid ester copolymer; homopolymers of aliphatic vinyl compounds such as polyethylene and polypropylene and their substitutes; vinyl resins such as polyvinyl acetate, polypropionate vinyl, polyvinyl benzoate, polyvinyl lactate, polyvinyl benzoate, polyvinyl formate, and polyvinyl butyral; vinyl ether resins; vinyl ketone resins; acrylic polymers; methacrylic polymers; silicone resins; polyester resins; polyamide resins; epoxy resins; phenolic resins; and rosin, modified rosin, and terpene resins. These can be used singly or in combination with multiple types.

Examples of polymerizable monomers which are used to form copolymers of aromatic vinyl compounds include the following compounds. Thus, the compounds include styrene and styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene.

Examples of polymerizable monomers which are used to form acrylic-type copolymers include acrylic polymerizable monomers such as acrylic acid, methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate.

Examples of polymerizable monomers which are used to form methacryl-type copolymers include methacrylic polymerizable monomers such as methacrylic acid, methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate.

As a polyester resin, a resin obtained by performing condensation polymerization of a carboxylic component and an alcohol component listed below can be used. Examples of the carboxylic component include terephthalic acid, isophthalic acid, phthalic acid, fumaric acid, maleic acid, cyclohexanedicarboxylic acid, and trimellitic acid. Examples of the alcohol component include bisphenol A, hydrogenated bisphenol, ethylene oxide adduct of bisphenol A, propylene oxide adduct of bisphenol A, glycerin, trimethylolpropane, and pentaerythritol.

Moreover, the polyester resin can be a polyester resin containing a urea group. It is favorable that, with regard to the polyester resin, a carboxyl group serving as, for example, a carboxyl terminal is not capped.

With a view to improving a viscosity change of the toner at high temperature, the binding resin can contain a polymerizable functional group. Examples of the polymerizable functional group include a vinyl group, an isocyanate group, an epoxy group, an amino group, a carboxyl group, and a hydroxyl group.

Among these, a styrene-series copolymer, represented by styrene-butyl acrylate, and a polyester resin are favorable in terms of, for example, development characteristics and fixability. Furthermore, the production method for a polymer is not particularly limited, and a known method can be used.

### <Ester Wax>

The toner particle in the present disclosure contains an ester wax as a release agent. 2.0 parts by mass or more of the ester wax is compatible with 100 parts by mass of the binding resin at 100° C.

The compatible amount relative to 100 parts by mass of the binding resin at 100° C. is hereinafter also referred to as a “saturated compatible amount”. It is thought that the saturated compatible amount is a numerical value indicating how much the ester wax is compatible with the binding resin and indicates the compatibility between the binding resin and the ester wax.

Even if the amount of an ester wax contained in a toner particle is the same, an ester wax the saturated compatible amount of which is larger causes an advantageous effect for the low-temperature fixability to become larger. It is favorable that the saturated compatible amount of the ester wax is 2.0 parts by mass or more, it is more favorable that the saturated compatible amount of the ester wax is 5.0 parts by mass or more, and it is further favorable that the saturated compatible amount of the ester wax is 10.0 parts by mass or more. On the other hand, the upper limit value of the saturated compatible amount is not particularly limited, it is favorable that the upper limit value is 100.0 parts by mass or less, it is more favorable that the upper limit value is 50.0 parts by mass or less, and it is further favorable that the upper limit value is 45.0 parts by mass or less. The numerical range of the saturated compatible amount can be formed by combining the above-mentioned lower and upper limit values in an optional manner. In a case where the saturated compatible amount satisfies the above-mentioned condition, a plasticization effect of the ester wax for the binding resin is sufficiently obtained, so that a good low-temperature fixability is exhibited.

It is favorable that the melting point of the ester wax is 55° C. or more and 100° C. or less, it is more favorable that the melting point of the ester wax is 60° C. or more and 100° C. or less, and it is further favorable that the melting point of the ester wax is 60° C. or more and 90° C. or less. If the melting point of the ester wax is 55° C. or more, the ester wax being wrapped around a fixing roller at the time of fixing becomes unlikely to occur, and, if the melting point of the ester wax is 100° C. or less, it is possible to obtain a sufficient low-temperature fixability.

The ester wax is not particularly limited as long as it satisfies the above-mentioned condition, and a known wax can be used as the ester wax. For example, an ester wax which is a condensate of an alcohol component and a carboxylic component is favorable because of being excellent in compatibility with a styrene acrylic copolymer or a polyester part contained in the binding resin.

More specifically, examples of the ester wax include a condensate of a fatty monoalcohol with a carbon number of 18 or more and 22 or less and a fatty monocarboxylic acid with a carbon number of 18 or more and 22 or less; a condensate of a fatty monoalcohol with a carbon number of 18 or more and 22 or less and a fatty dicarboxylic acid or aromatic dicarboxylic acid with a carbon number of 6 or more and 10 or less; a condensate of a fatty diol with a carbon number of 2 or more and 10 or less and a fatty monocarboxylic acid with a carbon number of 14 or more and 22 or less; and a condensate of a diethylene glycol and a fatty monocarboxylic acid with a carbon number of 18 or more and 22 or less.

Among these, a diester wax which is an ester compound of a fatty diol with a carbon number of 2 or more and 10 or less and a fatty monocarboxylic acid with a carbon number of 14 or more and 22 or less is favorable, and a diester wax which is an ester compound of a diol with a carbon number of 2 or more and 6 or less and a fatty monocarboxylic acid with a carbon number of 14 or more and 22 or less is more favorable.

Examples of the diol with a carbon number of 2 or more and 6 or less include ethylene glycol, diethylene glycol, 1,3-propanediol, 1,4-butanediol, and 1,6-hexanediol.

Examples of the fatty monocarboxylic acid with a carbon number of 14 or more and 22 or less include myristic acid, palmitic acid, stearic acid, and behenic acid.

Additionally, ethylene glycol distearate, which is an ester wax of ethylene glycol and stearic acid, is particularly favorable.

The carbon number of a diol component of the ester wax and the carbon number of a monocarboxylic acid thereof can be obtained by analyzing toner particles with a pyrolysis gas chromatography mass spectrometer (pyrolysis GC/MS). Such analysis is facilitated by preliminarily performing derivatization using, for example, a methylating agent, as needed.

It is favorable that the contained amount of the ester wax is 5.0 parts by mass or more and 30.0 parts by mass or less relative to 100.0 parts by mass of the binding resin, it is more favorable that the contained amount of the ester wax is 7.0 parts by mass or more and 30.0 parts by mass or less, and it is further favorable that the contained amount of the ester wax is 7.0 parts by mass or more and 20.0 parts by mass or less.

As long as the contained amount of the ester wax is within the above-mentioned ranges, a plasticization effect of the ester wax for the binding resin becomes better, so that an excellent low-temperature fixability is exhibited. Moreover, since the plasticization effect for the binding resin does not become excessive and the viscosity of the binding resin at the time of fixing does not decrease too much, the adhesiveness to paper becomes better, so that wrapping around the fixing roller is unlikely to occur. The contained amount of the ester wax can be obtained by dissolving toner particles using a solvent such as deuterated chloroform and performing carbon-13 nuclear magnetic resonance (¹³C-NMR) spectroscopy.

### <Other Waxes>

The toner particle in the present disclosure can contain a wax other than the above-described ester wax as needed to improve the releasability from paper. The wax to be contained is not particularly limited, and examples of the wax are as follows: aliphatic hydrocarbon-based waxes such as low molecular weight polyethylene, low molecular weight polypropylene, microcrystalline wax, Fischer-Tropsch wax, and paraffin wax; oxides of aliphatic hydrocarbon-based waxes such as oxidized polyethylene wax, or their block copolymers; saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralky alcohol, behenyl alcohol, carnaubil alcohol, ceryl alcohol, and myricyl alcohol; polyhydric alcohols such as sorbitol; fatty acid amides such as linoleic acid amide, oleic acid amide, and lauric acid amide; saturated fatty acid bisamides such as methylene bis-stearamide, ethylene bis-capramide, ethylene bis-lauramide, and hexamethylene bis-stearamide; unsaturated fatty acid amides such as ethylene bis-oleamide, hexamethylene bis-oleamide, N,N′-dioleyl adipamide, and N,N′-dioleyl sebacamide; aromatic bisamides such as m-xylylene bis-stearamide and N,N′-distearyl isophthalamide; aliphatic metal salts (commonly referred to as metallic soaps) such as calcium stearate, calcium laurate, zinc stearate, and magnesium stearate; and waxes grafted with vinyl monomers such as styrene or acrylic acid onto aliphatic hydrocarbon-based waxes. The wax can be used with one type or two or more types selected from the above-mentioned waxes in combination.

Among the above-mentioned waxes, it is favorable that the wax contains a hydrocarbon system wax.

It is favorable that the consumed amount of a wax other than the ester wax is 0.5 parts by mass or more and 20.0 parts by mass or less relative to 100.0 parts by mass of the binding resin.

### <Colorant>

The toner in the present disclosure can also use a colorant as needed. The colorant is not particularly limited, and, for example, the following known colorants can be used.

Examples of yellow pigments include yellow iron oxide, Naples yellow, naphthol yellow S, Hansa yellow G, Hansa yellow 10G, benzidine yellow G, benzidine yellow GR, quinoline yellow lake, permanent yellow NCG, condensed azo compounds such as tartrazine lake, isoindolinone compounds, anthraquinone compounds, azo metal complexes, methine compounds, and allylamide compounds. Specific examples of yellow pigments are as follows:

C.I. pigment yellows 12, 13, 14, 15, 17, 62, 74, 83, 93, 94, 95, 109, 110, 111, 128, 129, 147, 155, 168, and 180.

Examples of orange pigments are as follows:

permanent orange GTR, pyrazolone orange, Vulcan orange, benzidine orange G, indanthrene brilliant orange RK, and indanthrene brilliant orange GK.

Examples of red pigments include red iron oxide, permanent red 4R, lithol red, pyrazolone red, watching red calcium salt, lake red C, lake red D, brilliant carmine 6B, brilliant carmine 3B, eosin lake, rhodamine lake B, condensed azo compounds such as alizarin lake, and diketopyrrolopyrrole compounds, anthraquinone compounds, quinacridone compounds, basic dye lake compounds, naphthol compounds, benzimidazolone compounds, thioindigo compounds, and perylene compounds. Specific examples of red pigments are as follows:

C.I. pigment reds 2, 3, 5, 6, 7, 23, 48:2, 48:3, 48:4, 57:1, 81:1, 122, 144, 146, 166, 169, 177, 184, 185, 202, 206, 220, 221, and 254.

Examples of blue pigments include alkali blue lake, Victoria blue lake, phthalocyanine blue, metal-free phthalocyanine blue, phthalocyanine blue partial chloride, copper phthalocyanine compounds such as fast sky blue and indathrene blue BG and their derivatives, anthraquinone compounds, and basic dye lake compounds. Specific examples of blue pigments are as follows:

C.I. pigment blues 1, 7, 15, 15:1, 15:2, 15:3, 15:4, 60, 62, and 66.

Examples of violet pigments include fast violet B and methyl violet lake.

Examples of green pigments include pigment green B, malachite green lake, and final yellow green G. Examples of white pigments include zinc oxide, titanium oxide, antimony white, and zinc sulfide.

Examples of black pigments include carbon black, aniline black, non-magnetic ferrite, magnetite, and colorants which are color-matched to black using the above-mentioned yellow colorants, red colorants, and blue colorants. These colorants can be used singly or in mixtures thereof, and also in a solid solution state.

The colorant can be surface-treated, as needed, with a substance which does not cause inhibition of polymerization.

Furthermore, it is favorable that the consumed content of the colorant is 1.0 parts by mass or more and 15.0 parts by mass or less relative to 100.0 parts by mass of the binding resin or the polymerizable monomer.

### <Charge Control Agent>

The toner in the present disclosure can also use a charge control agent as needed. While a known agent can be used as the charge control agent, a charge control agent which has a high triboelectric charging rate and is capable of stably maintaining a constant triboelectric charge quantity is favorable. Additionally, in a case where the toner particle is produced according to a polymerization method, a charge control agent which has low polymerization inhibition properties and in which there is substantially no solubilized material in an aqueous medium is favorable.

The charge control agent can be a charge control agent which controls the toner so as to exhibit negative chargeability or a charge control agent which controls the toner so as to exhibit positive chargeability. Examples of charge control agents which control the toner so as to exhibit negative chargeability are as follows:

specifically, monoazo metal compounds, acetylacetone metal compounds, metal compounds of aromatic oxycarboxylic acids, aromatic dicarboxylic acids, oxycarboxylic acids, and dicarboxylic acids, aromatic oxycarboxylic acids, aromatic mono- and polycarboxylic acids and their metal salts, anhydrides, and esters, phenol derivatives such as bisphenols, urea derivatives, metal-containing salicylic acid-based compounds, metal-containing naphthoic acid-based compounds, boron compounds, quaternary ammonium salts, calixarenes, and resin-based charge control agents.

On the other hand, examples of the charge control agents which control the toner so as to exhibit positive chargeability are as follows:

specifically, nigrosin and modified products thereof with a fatty acid metal salt, guanidine compounds, imidazole compounds, onium salts such as quaternary ammonium salts, for example, tributylbenzylammonium 1-hydroxy-4-naphthosulfonate salt and tetrabutylammonium tetrafluoroborate, and phosphonium salts which are analogues of these, their lake pigments, triphenylmethane dyes and their lake pigments (examples of laking agents including phosphotungstic acid, phosphomolybdic acid, phosphotungstomolybdic acid, tannic acid, lauric acid, gallic acid, ferricyanide compounds, and ferrocyanide compounds), metal salts of higher fatty acids, and resin-based charge control agents.

The above-described charge control agent can be used singly or in combinations of two or more types. Among these charge control agents, a metal-containing salicylic acid-based compound is favorable, and, particularly, the compound in which the contained metal is aluminum or zirconium is favorable.

It is favorable that the additive amount of the charge control agent is 0.1 parts by mass or more and 20.0 parts by mass or less relative to 100.0 parts by mass of the binding resin, and it is more favorable that the additive amount is 0.5 parts by mass or more and 10.0 parts by mass or less.

Moreover, it is favorable to use, as a charge control resin, a polymer or copolymer having a sulfonic acid group, a sulfonic acid salt group, or a sulfonic acid ester group. It is favorable that the polymer having a sulfonic acid group, a sulfonic acid salt group, or a sulfonic acid ester group particularly contains 2 percent by mass or more, as a copolymerization ratio, of a sulfonic acid group-containing acrylamide-based monomer or a sulfonic acid group-containing methacrylamide-based monomer. It is more favorable that such a polymer contains 5 percent by mass or more, as a copolymerization ratio, of the above-mentioned monomer. It is favorable that the charge control resin has a glass transition temperature (Tg) of 35° C. or more and 90° C. or less, a peak molecular weight (Mp) of 10,000 or more and 30,000 or less, and a weight-average molecular weight (Mw) of 25,000 or more and 50,000 or less. In a case where such a charge control resin is used, a favorable triboelectric charging characteristics can be imparted, without the thermal characteristics required from the toner particle being affected. Additionally, since the charge control resin contains a sulfonic acid group, both the dispersibility of the charge control resin itself in a dispersion liquid of the colorant and the dispersibility of the colorant increase, so that coloring strength, transparency, and triboelectric charging characteristics can be enhanced.

### [External Additive]

The toner in the present disclosure can also use an external additive as needed. This enables controlling, for example, fluidity, chargeability, and cleaning properties.

Examples of external additives to be used include inorganic oxide fine particles composed of, for example, silica fine particles, alumina fine particles, or titanium oxide fine particles, fine particles of inorganic stearic acid compounds such as aluminum stearate fine particles or zinc stearate fine particles, and fine particles of inorganic titanate compounds such as strontium titanate or zinc titanate. These external additives to be used can be used singly or in combinations of two or more types.

It is favorable that the total additive amount of these external additives is 0.05 parts by mass or more and 10.00 parts by mass or less relative to 100 parts by mass of toner particles, and it is more favorable that the total additive amount is 0.1 parts by mass or more and 5.0 parts by mass or less.

Firmly fixing the external additive to the toner particle surface can be performed with use of a known method. Examples of the known method include a method of fixing using a Henschel Mixer (a dry method) and a method of fixing including dispersing toner particles and an external additive in a solvent and then aggregating the toner particles and the external additive (a wet method).

Moreover, in a favorable configuration, a spherical silica particle is used as the external additive. Since the spherical silica particle is unlikely to be buried in a toner particle, when the cracked toner particle has become a starting point for a member contamination, with regard to a toner particle surface portion originally existing in the spherical silica particle, covering by a cohesion cluster becomes unlikely to occur, so that, as a result, a broken-out section caused by cracking is preferentially covered by the spherical silica particle. Therefore, a long-term inhibition effect for a member contamination becomes larger. Specifically, a spherical silica particle which contains silicon and in which the number average particle diameter of a primary particle is 50 nm or more and 300 nm or less, the average value of shape factors SF-1 thereof is 105 or more and 120 or less, and the average value of shape factors SF-2 thereof is 100 or more and 130 or less is favorable.

The spherical silica particle is not particularly limited as long as it satisfies the above-mentioned condition, and examples of the spherical silica particle include sol-gel silica particles, fused silica particles, organic silicon polymer particles, and combinations thereof.

A wet silica particle can be suitably used as the spherical silica particle. Moreover, these particles can be surface-treated with, for example, a silane coupling agent, a titanium coupling agent, or a silicone oil.

Among them, it is favorable that the toner contains hydrotalcite as an external additive. By the toner containing hydrotalcite which has a chargeability with a polarity opposite to that of a silica fine particle serving as a primary component of the cohesion cluster, the chargeability of the toner, specifically, the charging rise property under a severe high-temperature and high-humidity environment, which is hard for charging rise, increases. This enables preventing or reducing the occurrence of a weak density resulting from a long-term use.

### [Production Method for Toner]

In the following description, an example of a method of obtaining the above-described toner particle is described, but is not limited to the one described below.

The production method for a toner particle is not particularly limited, and can use, for example, a suspension polymerization method, a dissolution suspension method, an emulsion aggregation method, or a pulverization method. As an example, a method of obtaining a toner particle according to the emulsion aggregation method is described as follows.

### <Production Method for Toner Particle (Toner Core Particle) According to Emulsion Aggregation Method>

### (Preparation Process for Resin Fine Particle Dispersion Liquid)

A resin fine particle dispersion liquid can be prepared by known methods, but the preparation method is not limited to such known methods. Examples of the preparation method include an emulsion polymerization method, a self-emulsification method, a phase inversion emulsification method of emulsifying a resin by gradually adding an aqueous medium to a resin solution dissolved in an organic solvent, and a forced emulsification method of forcibly emulsifying a resin by performing high-temperature treatment of the resin in an aqueous medium without using an organic solvent.

As an example, a method of preparing a resin fine particle dispersion liquid by the phase inversion emulsification method is described as follows.

The preparation method dissolves a resin component in an organic solvent in which these resin components are dissolvable, and adds an surfactant and basic compounds to the organic solvent. At that time, if the resin component is a crystalline resin having a melting point, the preparation method can heat the resin component to the melting point or more to dissolve the resin material. Next, the preparation method slowly adds an aqueous medium while performing agitation with, for example, a homogenizer, thus precipitating resin fine particles. After that, the preparation method performs heating or decompression to remove the solvent, thus producing an aqueous dispersion liquid for resin fine particles.

Here, the organic solvent to be used for dissolving resin components only needs to be a solvent available for dissolving these. Specifically, examples of the organic solvent include toluene and xylene.

Examples of the surfactant to be used at the time of the preparation process include anionic surfactants such as sulfate ester salts, sulfonate salts, carboxylate salts, phosphate esters, and soap-based surfactants; cationic surfactants such as amine salts and quaternary ammonium salts; and nonionic surfactants such as polyethylene glycol-based, alkylphenol ethylene oxide adduct-based, and polyhydric alcohol-based surfactants.

Examples of the basic compounds to be used at the time of the preparation process include inorganic bases such as sodium hydroxide and potassium hydroxide; and organic bases such as ammonia, triethylamine, trimethylamine, dimethylaminoethanol, and diethylaminoethanol. The basic compounds can be used singly in one type or in combinations of two or more types.

### (Preparation of Colorant Dispersion Liquid)

The preparation of a colorant dispersion liquid can be performed with use of a known dispersion method, and, for example, a common dispersion method such as a homogenizer, a ball mill, a colloid mil, or an ultrasonic disperser can be used, so that the preparation method is not limited at all. Moreover, examples of the surfactant to be used at the time of dispersion include the above-mentioned surfactants.

### (Preparation of Wax Dispersion Liquid)

The preparation method for a wax dispersion liquid disperses a wax as well as, for example, a surfactant and basic compounds under water and, after that, heats them to a temperature higher or equal to a melting point of the wax and performs dispersion processing on them with use of a homogenizer or a disperser to which a strong shearing force is imparted. With such processing being performed, a wax dispersion liquid is obtained. Examples of the surfactant to be used at the time of dispersion include the above-mentioned surfactants. Moreover, examples of the basic compounds to be used at the time of dispersion include the above-mentioned basic compounds.

### (Agglomerated Particle Formation Process)

An agglomerated particle formation process first mixes, for example, a resin fine particle dispersion liquid, a colorant dispersion liquid, and a wax dispersion liquid to make a mixed liquid. Next, the agglomerated particle formation process agglomerates the mixed liquid with the hydrogen ion exponent (pH) set acidic while heating the mixed liquid at a temperature lower than or equal to a melting point of the resin fine particle, and forms agglomerated particles containing resin fine particles, colorant particles, and release agent particles, thus obtaining an agglomerated particle dispersion liquid.

### (First Fusion Process)

A first fusion process increases the pH of the agglomerated particle dispersion liquid under an agitation condition corresponding to that in the agglomerated particle formation process, thus stopping the progression of agglomeration, and performs heating at a temperature higher than or equal to a melting point of the above-mentioned resin component, thus obtaining a fusion particle dispersion liquid.

### (Amorphous Resin Fine Particle Attachment Process)

An amorphous resin fine particle attachment process adds an amorphous resin fine particle dispersion liquid to the fusion particle dispersion liquid, thus decreasing the pH, and attaches amorphous resin particles to the surfaces of the fusion particles, thus obtaining a dispersion liquid of resin attachment particles. Here, the thus-formed covering layer is equivalent to a shell layer which is formed via a shell layer formation process described below. Furthermore, the amorphous resin fine particle dispersion liquid can be produced according to the above-described preparation process for resin fine particle dispersion liquid.

### (Second Fusion Process)

A second fusion process, as with the first fusion process, increases the pH of the resin attachment particle dispersion liquid, thus stopping the progression of agglomeration, and performs heating at a temperature higher than or equal to a melting point of the above-mentioned resin component to fuse the attachment resin agglomerated particles, thus obtaining toner particles with a shell layer formed therein.

### <Production Method for Toner Particle Having Cohesion Cluster>

For a production method for a toner particle having a cohesion cluster containing a silica fine particle and a binding component, from the viewpoint of evenly agglomerating a silica fine particle and a binding component, it is favorable to perform external addition to a toner core particle by a wet method. In the case of obtaining a toner particle having a cohesion cluster containing a silica fine particle and a binding component by a wet method, it is favorable to include:

(process 1) a process of obtaining a toner core particle dispersion liquid in which toner core particles are dispersed in an aqueous medium; and (process 2) a process of mixing silica fine particles and polymerizable monomers (monomers) serving as binding resin components with the toner core particle dispersion liquid, causing the monomers to develop a polymerization reaction in the toner core particle dispersion liquid, and thus forming a cohesion cluster containing a silica fine particle and a binding resin on the toner core particle.

In the process 1, examples of the method of obtaining a toner core particle dispersion liquid include a method of directly using a dispersion liquid of toner core particles produced in an aqueous medium, and a method of putting dried toner core particles into an aqueous medium and thus mechanically dispersing the dried toner core particles in the aqueous medium. In the case of dispersing the dried toner core particles in the aqueous medium, a dispersion aid can be used.

For example, a known dispersion stabilizer or surfactant can be used as the dispersion aid. Specifically, examples of the dispersion stabilizer include: inorganic dispersion stabilizers such as tricalcium phosphate, hydroxyapatite, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina; and organic dispersion stabilizers such as polyvinyl alcohol, gelatin, methyl cellulose, methyl hydroxypropyl cellulose, ethyl cellulose, sodium carboxymethyl cellulose, and starch.

Moreover, examples of the surfactant include:

anionic surfactants such as alkyl sulfate ester salts, alkylbenzenesulfonate salts, and fatty acid salts; nonionic surfactants such as polyoxyethylene alkyl ethers and polyoxypropylene alkyl ethers; and cationic surfactants such as alkylamine salts and quaternary ammonium salts.

In the process 1, it is favorable to adjust the toner core particle dispersion liquid in such a manner that the solid content concentration thereof becomes 10 parts by mass or more and 50 parts by mass or less.

In the process 2, silica fine particles and monomers serving as binding components can be directly added to the toner core particle dispersion liquid, or a dispersion liquid in which silica fine particles and the monomers have been preliminarily dispersed can be added to the toner core particle dispersion liquid. The method of dispersing silica fine particles and the monomers can include using the dispersion aid exemplified in the description of the process 1.

Examples of the binding component include a polymer composed of a monofunctional polymerizable monomer or a polyfunctional polymerizable monomer, a copolymer obtained by combining two or more types of these, and a mixture thereof.

Examples of the above-mentioned polymerizable monomer include: styrene; styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters such as vinyl acetate, vinyl propionate, vinyl butyrate, vinyl benzoate, and vinyl formate; vinyl ethers such as vinyl methyl ether, vinyl ethyl ether, and vinyl isobutyl ether; vinyl ketones such as vinyl methyl ketone, vinyl hexyl ketone, and vinyl isopropyl ketone; trifunctional silane compounds having a methacryloxyalkyl group as a substituent, such as γ-methacryloxypropyltrimethoxysilane, γ-methacryloxypropyltriethoxysilane, y-methacryloxyoctyltrimethoxysilane, γ-methacryloxypropyl diethoxymethoxysilane, and γ-methacryloxypropyl ethoxydimethoxysilane; and trifunctional silane compounds having an acryloxyalkyl group as a substituent, such as γ-acryloxypropyltrimethoxysilane, γ-acryloxypropyltriethoxysilane, γ-acryloxyoctyltrimethoxysilane, γ-acryloxypropyl diethoxymethoxysilane, and γ-acryloxypropyl ethoxydimethoxysilane.

Among these, from the viewpoint of having a high affinity for silica, it is favorable to use trifunctional silane compounds.

In the process 2, the production method adds and mixes silica fine particles and monomers serving as binding components to the toner core particle dispersion liquid. At this time, it is favorable to preliminarily adjust the temperature of the toner core particle dispersion liquid to a temperature suited for a polymerization reaction. After that, the production method performs polymerization of the added monomers by adding a polymerization initiator while mixing toner core particles, silica fine particles, and monomers, externally adds a cohesion cluster containing a silica fine particle and a binding component to the toner core particles, and thus obtains a dispersion liquid of toner particles.

A known polymerization initiator can be used without particular limitation as the polymerization initiator. Specifically, examples of the polymerization initiator are as follows:

peroxide-type polymerization initiators represented by, for example, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenylacetic acid-tert-hydroperoxide, tert-butyl performate, tert-butyl peracetate, tert-butyl perbenzoate, tert-butyl perphenylacetate, tert-butyl permethoxyacetate, per-N-(3-tolyl) palmitate-tert-butylbenzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide; and azo and diazo polymerization initiators represented by, for example, 2,2′-azobis(2,4-dimethylvaleronitrile), 2,2′-azobisisobutyronitrile, 1,1′-azobis(cyclohexane-1-carbonitrile), 2,2′-azobis-4-methoxy-2, 4-dimethylvaleronitrile, and azobisisobutyronitrile.

### (Filtration Process, Washing Process, Drying Process, Classification Process, and External Addition Process)

After that, the production method performs a filtration process for filtering and separating solid contents of toner particles, a washing process as needed, a drying process, and a classification process for particle size adjustment, thus obtaining toner particles. The toner particles can be directly used as a toner. It is also possible to, as needed, mix and attach toner particles and an external additive such as inorganic fine powder with use of a mixing machine, thus obtaining a toner.

### [Developer]

The toner in the present disclosure can also be used as a magnetic or non-magnetic one-component developer, but can also be used as a two-component developer by being mixed with a carrier.

For example, magnetic particles composed of known materials, such as metals such as iron, ferrite, and magnetite, and alloys of these metals with metals such as aluminum and lead, can be used as carriers. Among these, it is favorable to use ferrite particles. Moreover, the carrier to be used can be a coated carrier obtained by coating the surface of a magnetic particle with a coating agent such as a resin, or a resin-dispersed carrier obtained by dispersing a fine powder of a magnetic body in a binder resin.

It is favorable that the volume average particle diameter of the carrier is 15 micrometers (μm) or more and 100 μm or less, and it is more favorable that the volume average particle diameter of the carrier is 25 μm or more and 80 μm or less. [Measuring Method for Physical Property]

Methods of measuring various physical properties concerning the toner in the present disclosure are described as follows.

### <Structure Confirmation Method for Ester Wax and Binding Resin Contained in Toner>

The method measures the saturated compatible amount of an ester wax relative to 100 parts by mass of the binding resin at 100° C. as follows.

First, the method extracts an ester wax from the toner particle. The extraction of an ester wax included in the toner particle is performed by separating an extract using tetrahydrofuran (THF) according to a solvent gradient elution method. The preparation method is as follows.

The preparation method weighs 10.0 grams (g) of toner particles, puts the toner particles in cylindrical filter paper (No. 84, manufactured by Toyo Roshi Kaisha, Ltd.), and places the cylindrical filter paper in a Soxhlet extractor. A solid substance obtained by performing extraction for 20 hours with 200 milliliters (mL) of THE used as a solvent and desolvating an extracted solution is a THF soluble content. The THF soluble content contains an ester wax. The preparation method performs this operation a plurality of times, thus obtaining a required amount of THF soluble content.

The solvent gradient elution method uses a gradient preparative high-performance liquid chromatography (HPCL) (LC-20 AP high-pressure gradient separative system, manufactured by Shimadzu Corporation, and SunFire separative column q 50 millimeters (mm)×250 mm, manufactured by Waters Corporation). The solvent gradient elution method sets a column temperature of 30° C. and a flow rate of 50 mL per minute, and, for a mobile phase, selects, as appropriate, THF, chloroform, or toluene as a good solvent and selects, as appropriate, acetonitrile, acetone, methanol, or n-hexane as a poor solvent. The solvent gradient elution method sets a content obtained by dissolving 0.02 g of THF soluble content in 1.5 mL of good solvent as a specimen and places the specimen in the gradient preparative HPCL. The solvent gradient elution method starts the mobile phase with a composition of 100% of poor solvent, increases the proportion of a good solvent by 4% per minute when 5 minutes have passed after specimen injection, causes the composition of the mobile phase to reach 100% of good solvent over 25 minutes. The solvent gradient elution method dries the obtained fractions, thus obtaining an ester wax. Which fraction component is an ester wax can be determined by a known analytical method such as 1H-NMR analysis, 13C-NMR analysis, Fourier Transform Infrared Spectroscopy (FT-IR) analysis, Gas Chromatography Mass Spectrometry (GC-MS) analysis, or gel permeation chromatography (GPC) analysis. The solvent gradient elution method is able to identify the type and structure of an ester wax included in the toner particle by the above-mentioned analysis method.

Next, the method extracts a binding resin from the toner particle. The binding resin is obtained by a separation operation using the above-mentioned solvent gradient elution method. This enables identifying the type and structure of a binding resin included in the toner particle by a known analytical method such as 1H-NMR analysis, 13C-NMR analysis, FT-IR analysis, GC-MS analysis, or GPC analysis.

### [Measuring Method for Saturated Compatible Amount of Ester Wax and Binding Resin>

The method prepares an ester wax and a binding resin which are obtained by the above-described operation. The method can obtain the ester wax and the binding resin by chemical synthesis from the obtained structure.

The method measures and puts 1.00 g of the binding resin obtained by the above-described operation in a 30 mL vial container, and heats the vial container to 100° C. After that, the method adds the ester wax to the vial container, sufficiently mixes the binding resin and the ester wax at 100° C., and performs visual observation of the mixture.

With regard to the presence or absence of compatibility, if transparency is found by the visual observation, the method determines that compatibility is present.

The method gradually adds the ester wax by 0.005 g (0.5 parts by mass relative to the binding resin) at one time, and obtains the greatest amount of ester wax obtained when it is still determined that compatibility is present without the occurrence of white turbidity.

<Method of Confirming that Silica Fine Particle and Binding Component are Contained in Cohesion Cluster>

The confirmation that a silica fine particle and a binding component are contained in a cohesion cluster is performed with use of a scanning transmission electron microscope and energy dispersive X-ray spectroscope (STEM-EDX) and a scanning electron microscope.

First, with respect to a toner having a cohesion cluster, the method conducts the evaluation of a cross-section structure and composition of the cohesion cluster with use of the STEM-EDX.

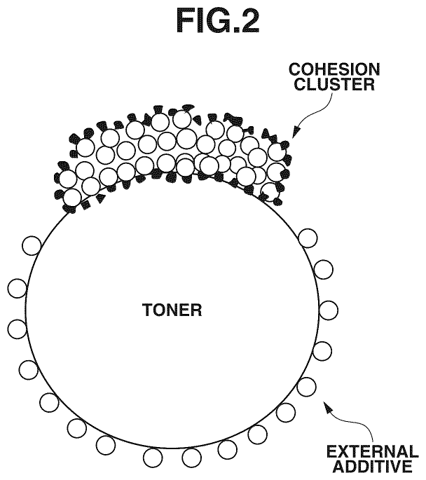

The method applies an osmium (Os) film (5 nm) and a naphthalene film (20 nm) as protective films to the toner with use of an osmium plasma coater (OPC80T, manufactured by Filgen, Inc.), performs embedding with a photo-curable resin D800 (manufactured by JEOL Ltd.), and then produces a toner particle cross-section with a film thickness of 100 nm at a cutting speed of 1 mm per second(s) with an ultrasonic ultramicrotome (UC7, manufactured by Leica Microsystems GmbH). At this time, the method can collectively process a plurality of toners and obtain toner cross-sections of 300 to 500 particles. FIG. 2 is a schematic diagram of a cross-section of the toner having a cohesion cluster.

With respect to the obtained cross-section, the method performs STEM-EDX observation using an STEM function of transmission electron microscopy and energy dispersive X-ray analysis (TEM-EDX) (TEM: manufactured by JEOL Ltd., JEM2800 (200 keV), an EDX detector: manufactured by JEOL Ltd., dry SD 100GV, and an EDX system: manufactured by Thermo Fisher Scientific Inc., NORAN SYSTEM7). The method acquires observations by cumulating 50 frames while performing adjustment in such a manner that the probe size for STEM is 1.0 nm, the observation magnification is 50 to 300 k (K=1,000), the image size for EDX is 256 pixels×256 pixels, and the save rate is 10,000 cycles per second (cps). With regard to the observation location, the method sets the field of view in such a manner that a cohesion cluster present on the outer circumferential portion of a toner particle fits into the field of view.

Whether a particle composed mainly of silica and a binding component are present in a cohesion cluster can be determined by confirming that a portion in which many silicon and oxygen atoms are found and a portion in which many elements derived from a binding component are found are separately present at the same place. In a case where a resin is used for the binding component, many carbon atom are found.

Next, with respect to the toner having a cohesion cluster, the method conducts an observation of a reflection electron image using a scanning electron microscope (SEM). The reflection electron image, which is obtained by the SEM, is also called a “composition image”, and atoms of lower atomic number are detected as being darker and atoms of higher atomic number are detected as being brighter.

The toner particle is commonly a resin particle containing mainly a resin component and a composition composed mainly of carbon such as a release agent. In a case where a silica fine particle or a metal oxide is present on the toner particle surface, in a reflection electron image which is obtained by the SEM, the silica fine particle or the metal oxide is observed as a bright portion and a resin portion composed mainly of carbon is observed as a dark portion. The image capturing condition is as follows.

### (1) Specimen Preparation

The method puts a carbon tape on a specimen mount (an aluminum specimen mount, 12.5 mm q (diameter)×6 mm t (thickness)), and places the toner on the carbon tape. Additionally, the method performs air blowing to remove extra specimens from the specimen mount. The method sets the specimen mount onto a specimen holder, thus setting the toner on a scanning electron microscope (Ultra Plus, manufactured by Carl Zeiss AG).

### (2) Electron Microscope Observation Condition Setting

The confirmation that a cohesion cluster containing a silica fine particle and a binding component is present is performed with use of an image obtained by reflection electron image observation with the Ultra Plus. Since, in the reflection electron image, an image contrast varies according to elemental compositions, it is possible to determine the presence or absence of a silica fine particle or a binding component contained in a cohesion cluster. The measurement condition is as follows.
Equipment used: ULTRA PLUS manufactured by Carl Zeiss Microcopy Co., Ltd.,
Acceleration voltage: 0.7 kilovolt (kV),
Working distance (WD): 2.0 mm,
Aperture size: 30.0 micrometers (μm),
Detection signal: energy selective backscattered electrons (EsB),
EsB grid: 500 volt (V),
Contrast: 63.0±5.0% (reference value),
Brightness: 38.0±5.0% (reference value),
Resolution: 1024×768, and
   Preprocessing: sparging toner particles to the carbon tape (evaporation coating not being performed).

The method sets the contrast and the brightness as appropriate according to the state of the equipment used. Moreover, the method sets the acceleration voltage and the EsB grid in such a way as to achieve items such as acquisition of structural information about the outermost surface of a toner particle, charge-up prevention of an unevaporated specimen, and selective detection of high-energy reflection electrons. The method selects, as an observational field of view, the vicinity of an apex at which the curvature of a toner particle becomes the smallest.

### (3) Focus Adjustment

The method sets the observation magnification to 30,000 (30 k) magnifications, and adjusts the alignment and stigma. Next, the method fits the field of view to a region having a configuration deemed to be a cohesion cluster at an appropriate observation magnification. When finding from the obtained reflection electron image that two types of contrasts, i.e., a contrast appearing to correspond to a silica fine particle and a contrast appearing to correspond to a binding component, are present, the method is able to determine that the observed configuration is the same as a cohesion cluster found by performing composition observation with the STEM-EDX.

### (Confirmation Method for Dispersion State of Binding Component Contained in Cohesion Cluster)

The method calculates the dispersion state of a binding component contained in a cohesion cluster with use of a reflection electron image of the cohesion cluster present on the toner surface. The method acquires the reflection electron image of the cohesion cluster present on the toner surface in a way similar to that in the acquisition method for a reflection electron image on the toner surface.

With respect to the obtained reflection electron image, the method calculates the dispersion state of a binding component contained in a cohesion cluster with use of image processing software ImageJ (originally developed by Wayne Rasband). The procedure for calculating the dispersion state is as follows.

First, the method converts, via “Type” in the Image menu, a reflection electron image of the analysis target into an 8-bit image. Next, the method sets, via “Filters” in the Process menu, the Median diameter to 2.0 pixels and thus reduces an image noise. The method estimates the image center with the exception of an observation condition display portion displayed in the lower part of the reflection electron image, and selects a range in all four directions within 1.5 μm of the image center of the reflection electron image with use of “Rectangle Tool” in the toolbar.

Next, the method selects “Threshold” via “Adjust” in the Image menu. In response to a manual operation, the method selects all of the pixels falling under luminance B1, and clicks “Apply” to obtain a binary image. This operation causes pixels falling under luminance A1 to be displayed in black (a pixel group A1) and causes pixels falling under luminance A2 to be displayed in white (a pixel group A2). Again, the method estimates the image center with the exception of an observation condition display portion displayed in the lower part of the reflection electron image, and selects a range in all four directions within 1.5 μm of the image center of the reflection electron image with use of “Rectangle Tool” in the toolbar.

Next, the method preliminarily selects a scale bar in the observation condition display portion which is displayed in the lower part of the reflection electron image with use of a straight line tool (Straight Line) in the toolbar. In response to “Set Scale” in the Analyze menu being selected in that condition, a new window is opened, and the pixel distance of a straight line which is currently selected in the “Distance in Pixels” field is input to the new window.

In response to the value (for example, 100) of the above-mentioned scale bar being input to the “Known Distance” field of the window, the unit (for example, nm) of the above-mentioned scale bar being input to the “Unit of Measurement” field thereof, and the “OK” button being clicked, the scale setting is completed.

Next, the method selects “Set Measurements” in the Analyze menu, and checks “Area” and “Feret's diameter”. In response to “Analyze particles” in the Analyze menu being selected, “Display Result” being checked, and the “OK” button being clicked, the method performs domain analysis.

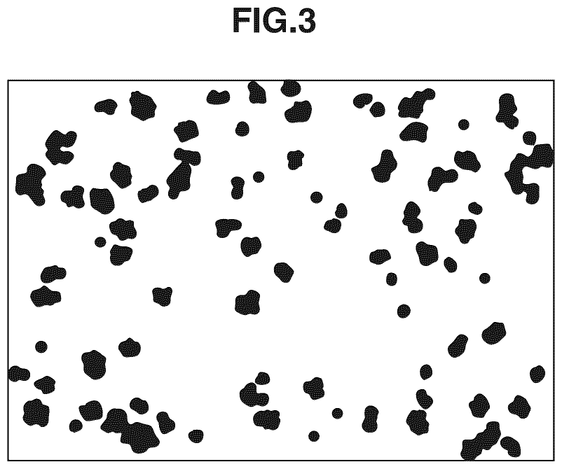

Next, with respect to the obtained analysis image, the method performs Erode processing for 10 pixels with use of ImageJ, and, after that, further performs Dilate processing for 10 pixels with use of ImageJ. Furthermore, with regard to the Erode processing and Dilate processing, the method performs processing starting with an item of Binary in the Process menu. FIG. 3 illustrates, as an example, an image which is obtained by performing the above-described processing.

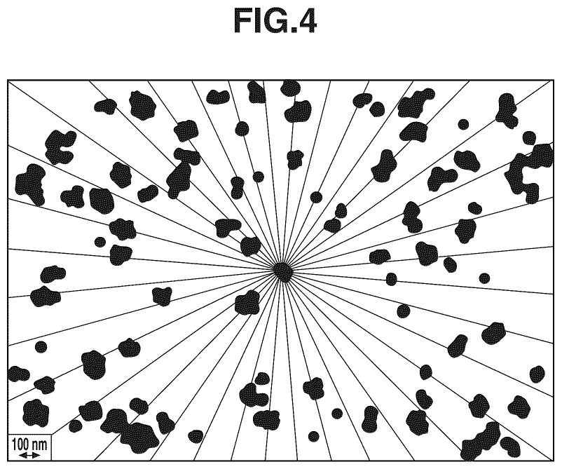

With respect to the analysis image obtained by the above-described processing, the method draws a total of 18 straight lines, as line segments, each extending from an end to an end of the analysis image at intervals of 10° in such a way as to, with a center of the analysis image set as a reference point, cause all of the line segments to pass through the reference point. FIG. 4 illustrates, as an example, the image obtained by drawing the above-mentioned line segments.

Next, the method measures the length L of a line segment on which a bright portion continues on each of the straight lines, counts the number of straight lines each of which has a line segment with the length L being 100 nm or more, and checks whether the counted number of line segments is 12 or more in the cohesion cluster concerned.

<Confirmation Method for Ratio of Toner Particles each having Cohesion Cluster in which Number of Straight Lines is 12 or More>

With respect to 30 toner particles each having a cohesion cluster included in the toner targeted for evaluation, the method performs the above-described procedure on each cohesion cluster, counts the number of toner particles each having a cohesion cluster in which the number of straight lines is 12 or more, and calculates a ratio A of the toner particles each having a cohesion cluster in which the number of straight lines is 12 or more, by the following formula:

$$A = \{ ( the number of toner particles each having a cohesion cluster in which the number of straight lines is 12 or more ) / 30 \} .$$

### <Observation Method for Toner and Calculation Method for Number of Toner Particles>

The method observes the toner with a scanning electron microscope (SEM). The equipment of SEM and the observation condition are as follows:
Equipment used: ULTRA PLUS manufactured by Carl Zeiss Microscopy Co., Ltd.,
Acceleration voltage: 1.0 kV,
Working distance (WD): 2.0 mm,
Aperture size: 30.0 μm,
Detection signal: secondary electrons (SE2),
Observation magnification: 2,000 magnifications,
Contrast: 45.0±5.0% (reference value),
Brightness: 38.0±5.0% (reference value),
Resolution: 1024×768, and
Preprocessing: sparging toner particles to the carbon tape (evaporation coating not being performed).

The method sets the contrast and the brightness as appropriate according to the state of the equipment used. Moreover, the method sets the acceleration voltage in such a way as to achieve items such as acquisition of structural information about the outermost surface of a toner particle and charge-up prevention of an unevaporated specimen.

With regard to the number of observation fields of view, the method counts the number of toner particles the entirety of each of which falls within the observation field of view in the obtained secondary electron image, and, with the counted number being denoted by Tall (number), continues performing observation up to the number of fields of view for which Tall becomes 300 or more.

### <Confirmation Method for Area Ratio of Binding Component Contained in Cohesion Cluster>

The method calculates the area ratio of a binding component using a reflection electron image of a cohesion cluster on the toner surface based on a domain D1 of the binding component and a domain D2 which is not the binding component. The method acquires the reflection electron image of the cohesion cluster on the toner surface in a way similar to that in the acquisition method for a reflection electron image on the toner surface.

The method conducts an analysis of the domain D1 and the domain D2 by processing a reflection electron image on the outermost surface of the toner particle acquired in the above-mentioned method with use of image processing software ImageJ (originally developed by Wayne Rasband). The procedure for calculating the area ratio is as follows.

First, the method converts, via “Type” in the Image menu, a reflection electron image of the analysis target into an 8-bit image. Next, the method sets, via “Filters” in the Process menu, the Median diameter to 2.0 pixels and thus reduces an image noise. The method estimates the image center with the exception of an observation condition display portion displayed in the lower part of the reflection electron image, and selects a range in all four directions within 1.5 μm of the image center of the reflection electron image with use of “Rectangle Tool” in the toolbar.

Next, with use of a Freehand selections function in the Image menu, the method selects only a portion in which a carbon atom portion of the mapping image and a dark portion of the reflection electron image coincide with each other, and fills the entire selected portion with black. Moreover, the method fills, with white, all of the portions other than the portion in which a carbon atom portion of the mapping image and a dark portion of the reflection electron image coincide with each other. Next, the method selects “Threshold” via “Adjust”. In response to a manual operation, the method selects, as a threshold value, “128”, which is a middle gradation between black and white in the 8-bit image, and clicks “Apply” to obtain a binary image.

This operation causes pixels falling under the domain D1 (binding component) to be displayed in black (a pixel group A1) and causes pixels falling under the domain D2 (other than the binding component) to be displayed in white (a pixel group A2).

Again, the method estimates the image center with the exception of an observation condition display portion displayed in the lower part of the reflection electron image, and selects a range in all four directions within 1.5 μm of the image center of the reflection electron image with use of “Rectangle Tool” in the toolbar.

Next, the method preliminarily selects a scale bar in the observation condition display portion which is displayed in the lower part of the reflection electron image with use of a straight line tool (Straight Line) in the toolbar. In response to “Set Scale” in the Analyze menu being selected in that condition, a new window is opened, and the pixel distance of a straight line which is currently selected in the “Distance in Pixels” field is input to the new window.

In response to the value (for example, 100) of the above-mentioned scale bar being input to the “Known Distance” field of the window, the unit (for example, nm) of the above-mentioned scale bar being input to the “Unit of Measurement” field thereof, and the “OK” button being clicked, the scale setting is completed.

Next, the method selects “Set Measurements” in the Analyze menu, and checks “Area” and “Feret's diameter”. In response to “Analyze particles” in the Analyze menu being selected, “Display Result” being checked, and the “OK” button being clicked, the method performs domain analysis.

Via the new opened Results window, the method acquires the areas (Area) of the respective domains corresponding to the domain D1 formed from the pixel group A1 and the domain D2 formed from the pixel group A2.

The method denotes the sum of areas for the domain D1 as S1 (square micrometers (μm²)) and denotes the sum of areas for the domain D2 as S2 (μm²). The method calculates the area ratio S of the binding component from the obtained S1 and S2 by the following formula:

$$S ( percent by area ) = \{ S 1 / ( S 1 + S 2 ) \} \times 100 .$$

The method performs the above-described procedure with respect to 10 fields of view per a toner particle targeted for evaluation, and uses the arithmetic average value as an area ratio.

<Calculation Method for Number CI of Toner Particles each having Cohesion Cluster>

In secondary electron images for all of the number of fields of view obtained by the above-described observation, the method counts the number of toner particles each having a cohesion cluster from among toner particles the entirety of each of which falls within the observation field of view, and denotes the counted number as Tagg (number). Thus, the method counts the number of toners each having a cohesion cluster such as a toner illustrated in FIG. 1.

The method calculates the number CI (percent by number) from the obtained Tall (number) and Tagg (number) by the following formula:

$$CI ( percent by number ) = Tagg / Tall \times 100.$$

<Calculation Method for Numbers Ca and Cb of Toner Particles Each Having a Cohesion Cluster Obtained when Ultrasonic Processing has been Performed>

The method puts about 10 milliliters (mL) of deionized water with, for example, impure solid matter preliminarily removed in a container made of glass.

The method adds, as a dispersant, about 0.5 mL of a diluted solution obtained by diluting “Contaminon N” (10 percent by mass of aqueous solution of neutral detergent for precision measurement device washing of pH7 composed of a non-ionic surfactant, an anionic surfactant, and an organic builder, manufactured by FUJIFILM Wako Pure Chemical Corporation) about 3 times by mass with deionized water to the content of the container. Additionally, the method adds about 0.02 g of measurement sample, and, while agitating the content of the container, performs the following dispersion treatment thereon with use of an ultrasonic disperser, thus forming a dispersion liquid for measurement. At that time, the method appropriately cools the dispersion liquid in such a way as to cause the temperature of the dispersion liquid to become 10° C. or more and 40° C. or less. The method uses, as the ultrasonic disperser, an ultrasonic homogenizer with an oscillatory frequency of 30 kHz (VP-050, manufactured by TAITEC corporation), causes a vibration unit thereof to enter the dispersion liquid by 1.0 centimeters (cm), and vibrates the dispersion liquid under the following ultrasound condition A or ultrasound condition B:
ultrasound condition A: an output frequency of 30 kHz, an output capacity of 0.75 W, and an irradiation time of 300 s, and
ultrasound condition B: an output frequency of 30 kHz, an output capacity of 30 W, and an irradiation time of 300 s.

The method filtrates the dispersion liquid obtained by the above-described procedure with use of KIRIYAMA chromatography paper (No. 5C, hole diameter of 1 μm), separates particles and a filtrate, further washes the obtained particles with 100 parts by mass of deionized water, and performs vacuum drying on the washed particles at 25° C. for 24 hours, thus obtaining powders to be used for measuring the numbers Ca and Cb of toner particles each having a cohesion cluster.

With respect to the obtained powders, the method calculates the Ca and Cb by a procedure similar to <Calculation Method for Number CI of Toner Particles each having Cohesion Cluster>, and checks whether the CI, the Ca, and the Cb satisfy the following formulae (1) and (2):

$$0.9 \leq Ca / CI \leq 1. , and \qquad ( 1 )$$

$$0.05 \leq Cb / CI \leq 0 \text{.25} . \qquad ( 2 )$$

<Size Measuring Method for Cohesion Cluster and Counting Method for Toner Particles each having Cohesion Cluster>

In the above-described scanning electron microscope observation, the method captures an image of the entire toner at an appropriate magnification (5 k magnifications to 10 k magnifications) and stores the captured image. The method sets the image resolution to 1024 pixels×768 pixels.

With regard to the obtained SEM image, the method selects, on the image, a portion which is determined as a cohesion cluster with use of image analysis software ImageJ (originally developed by Wayne Rasband). The size of a cohesion cluster is defined by the maximum Feret diameter of such a selected region. The method performs calculation in the following procedure:
(1) the method performs setting of a scale by “[Analyze]-[Set Scale]”,
(2) the method checks “[Analyze]-[Set Measurements]-[Feret's diameter]”,
(3) the method selects “[Freehand Selections]” and selects a cohesion cluster on the image by handwriting,
(4) the method selects “[Analyze]-[Measure]” and obtains the maximum Feret diameter (Feret) of the selected portion,
(5) in a case where a plurality of cohesion clusters is present on the image, the method repeats the steps (3) and (4),
(6) the method conducts a similar analysis with respect to 9 remaining images in each of which a toner particle having a cohesion cluster the maximum Feret diameter of which is 500 nm or more has been observed, and
(7) the method sets the maximum value of Feret (Feret diameter) of the obtained analysis results as a maximum Feret diameter, and determines, as a cohesion cluster, a cluster the maximum Feret diameter of which is 500 nm or more.

The method optionally observes toner particles by a scanning electron micrometer, and denotes an arithmetic mean value of maximum Feret diameters of a total of 100 cohesion clusters as Ag.

Moreover, from among the optionally observed toner particles, the method denotes the percent by number of toner particles each having a cohesion cluster as CI.

### <Measuring Method for SF-1, SF-2, and Particle Diameter of External Additive>

The method measures shape factors SF-1 and SF-2 of the external additive by observing an external additive on the toner surface with a scanning electron microscope (SEM) “S-4800” (manufactured by Hitachi, Ltd.). In a case where the external additive is currently isolated, the method can directly observe the isolated external additive. Specifically, in the field of view magnified 100,000 times to 200,000 times, the method evaluates the maximum length, circumferential length, and area of the external additive with use of image processing software Image-Pro Plus 5.1J (manufactured by Media Cybernetics, Inc.), and calculates the SF-1 and SF-2 by the following formulae. In this way, the method obtains the average values for 100 external additives, and defines the obtained average values as SF-1 and SF-2 of the external additive.

$$SF - 1 = {( maximum length of externa additive )}^{2} / area of external additive \times π / 4 \times 100 ,$$

$$and$$

$$SF - 2 = {( maximum length of externa additive )}^{2} / area of external additive \times 100 / 4 π .$$

Moreover, similarly, with regard to the maximum length of the external additive, the method obtains the average value for 100 external additives, and defines the obtained average value as the particle diameter of the external additive.

### EXAMPLES

Aspects of the present disclosure are described in detail below with reference to the following production examples and Examples of the present disclosure. However, these do not limit the invention in any way. Furthermore, “parts” in the production examples and Examples are all defined based on mass unless otherwise described.

### <Preparation of Resin Particle Dispersion Liquid 1>

The method mixed and dissolved 78.0 parts of styrene, 20.7 parts of butyl acrylate, 1.3 parts of acrylic acid serving as a carboxyl group imparting monomer, and 3.2 parts of n-lauryl mercaptan to form a solution. The method added, to the formed solution, the entire quantity of an aqueous solution obtained by dissolving 2.0 parts of straight-chain sodium alkylbenzene sulfonate (product name: NEOGEN RK (manufactured by DKS Co., Ltd.) with 150 parts of deionized water, and dispersed the solution.

Additionally, while slowly agitating the solution for 10 minutes, the method added, to the solution, an aqueous solution of 0.3 parts of potassium persulfate and 10 parts of deionized water. After performing nitrogen substitution, the method performed emulsion polymerization for 6 hours at 70° C. After the end of polymerization, the method cooled the reaction solution to room temperature and added deionized water to the cooled reaction solution, thus obtaining a resin particle dispersion liquid 1 with a solid content concentration of 12.5 percent by mass and a volume-based median diameter of 0.2 μm.

### <Preparation of Resin Particle Dispersion Liquid 2>

The method introduced the following acid components and alcohol component into a reaction tank equipped with a nitrogen introduction tube, a dewatering conduit, an agitator, and a thermocouple:
terephthalic acid: 40.0 parts by mol,
isopropyl acrylate: 3.0 parts by mol,
trimellitic anhydride: 6.0 parts by mol,
propylene oxide 2-mol adduct of bisphenol A: 30.0 parts by mol,
ethylene oxide 2-mol adduct of bisphenol A: 10.0 parts by mol, and
ethylene glycol: 6.0 parts by mol.

The method added 1.5 parts of dibutyltin as a catalyst to a total of 100 parts of monomers. Next, the method quickly performed incalescence up to 180° C. at normal pressures under a nitrogen atmosphere, and, after that, while performing heating from 180° C. to 210° C. at a speed of 10° C. per hour, distilled away water and performed condensation polymerization. After the temperature reaching 210° C., the method depressurized the inside of the reaction tank to 5 kilopascal (kPa) or less, performed condensation polymerization under the condition of 210° C. and 5 kPa or less, and thus obtaining a polyester resin 1. At that time, the method adjusted a polymerization time in such a way as to cause the softening point of the obtained polyester resin 1 to become 126° C.

The method put 100.0 parts of polyester resin 1 and 350 parts of deionized water into a container made of stainless steel, and performed heating and melting up to 95° C. under a hot bath. After that, while performing sufficient agitation at 7,800 revolutions per minute (rpm) with use of a homogenizer (ULTRA-TURRAX T50, manufactured by IKA Works GmbH & Co. KG), the method added 0.1 mol per liter (L) of sodium hydrogen carbonate to the solution to cause the hydrogen-ion exponent (pH) thereof to become larger than 7.0.

After that, the method gradually dripped a mixed solution of 3.0 parts of straight-line sodium alkylbenzene sulfonate and 300 parts of deionized water, performed emulsion and dispersion, and thus obtained a polyester resin particle dispersion liquid. The method cooled the dispersion liquid to room temperature and added deionized water to the cooled dispersion liquid, thus obtaining a resin particle dispersion liquid 2 with a solid content concentration of 12.5 percent by mass and a volume-based median diameter of 0.2 μm.

### <Preparation of Release Agent Dispersion Liquid 1>

The method mixed 100 parts of release agent (Fischer-Tropsch wax, melting point of 78° C.) and 15 parts of aliphatic alcohol alkylene oxide adduct with 385 parts of deionized water, performed dispersion for about 1 hour with use of a wet jet mill JN100 (manufactured by JOKOH Co., Ltd.), and thus obtained a release agent dispersion liquid 1.

The concentration of the release agent dispersion liquid 1 was 20 percent by mass.

### <Preparation of Release Agent Dispersion Liquids 2 to 6>

The method obtained release agent dispersion liquids 2 to 6 by performing similar operations except that materials shown in Table 1 were used as release agents.

The concentration of each of the release agent dispersion liquids 2 to 6 was 20 percent by mass.

TABLE 1

| Release agent | | Melting point |
|---|---|---|
| dispersion liquid | Release agent material | (° C.) |
| 1 | Fischer-Tropsch wax | 78 |
| 2 | ethylene glycol distearate | 76 |
| 3 | sebacic acid distearyl | 65 |
| 4 | behenyl behenate | 73 |
| 5 | dipentaerythritol hexabehenate | 86 |
| 6 | carnauba wax | 84 |

### <Preparation of Colorant Dispersion Liquid 1>

The method mixed 100 parts of carbon black “Nipex 35” (manufactured by Orion Engineered Carbons S.A.) and 15 parts of aliphatic alcohol alkylene oxide adduct with 885 parts of deionized water, performed dispersion for about 1 hour with use of the wet jet mill JN100, and thus obtained a colorant dispersion liquid 1.

### <Production of Toner Core Particle 1>

### (Dispersion Process)

The method dispersed 265 parts of resin particle dispersion liquid 1, 5 parts of release agent dispersion liquid 1, 15 parts of release agent dispersion liquid 2, 10 parts of colorant dispersion liquid 1, 2.9 parts of aliphatic alcohol alkylene oxide adduct, and 0.6 parts of straight-chain sodium alkylbenzene sulfonate (NEOGEN RK) with use of a homogenizer (ULTRA-TURRAX T50, manufactured by IKA Works GmbH & Co. KG). The method adjusted the temperature of the inside of the container to 30° C. while performing agitation, added 1 mol per L of aqueous sodium hydroxide, and adjusted the hydrogen-ion exponent (pH) of the solution to “pH=8.0”.

### (Agglomeration Process)

The method added, as a flocculant, an aqueous solution obtained by dissolving 0.08 parts of aluminum chloride in 10 parts of deionized water, over 10 minutes under agitation at 30° C. After leaving the solution untreated for 3 minutes, the method started incalescence, increased the temperature to 50° C., and thus generated associated particles. In that condition, the method measured the particle diameters of the associated particles by a Coulter counter “Multisizer 3” (TM, manufactured by Beckman Coulter, Inc.). At the time point of the weight-average particle diameter becoming 7.0 μm, the method added 0.9 parts of sodium chloride and 5.0 parts of aliphatic alcohol, and thus stopped the particle growth.

After adding 1 mol per L of aqueous sodium hydroxide and performing adjustment for “pH=9.0”, the method increased the temperature to 95° C. and thus performed conglobation of aggregated particles. In response to the mean degree of circularity reaching to 0.980, the method started the temperature decrease, performed cooling to room temperature, and thus obtained a dispersion liquid of toner core particle 1.

### <Production of Toner Core Particles 2 to 16>

The method produced dispersion liquids of toner core particles 2 to 16 by performing similar operations except that the resin particle dispersion liquid 1 and the release agent dispersion liquid 2 in the production of the toner core particle 1 were changed as shown in Table 2.

TABLE 2

| | Dispersion liquids used | | | |
|---|---|---|---|---|
| Toner | Resin particle | Release agent | Release agent | Colorant |
| core | dispersion | dispersion | dispersion | dispersion |
| particle | liquid | liquid | liquid | liquid |
| 1 | 1 | 1 | 2 | 1 |
| 2 | 1 | 1 | 2 | 1 |
| 3 | 1 | 1 | 3 | 1 |
| 4 | 1 | 1 | 4 | 1 |
| 5 | 1 | 1 | 4 | 1 |
| 6 | 2 | 1 | 2 | 1 |
| 7 | 2 | 1 | 3 | 1 |
| 8 | 2 | 1 | 4 | 1 |
| 9 | 2 | 1 | 4 | 1 |
| 10 | 1 | 1 | 5 | 1 |
| 11 | 1 | 1 | 2 | 1 |
| 12 | 1 | 1 | 4 | 1 |
| 13 | 1 | 1 | 2 | 1 |
| 14 | 1 | 1 | 4 | 1 |
| 15 | 1 | 1 | 4 | 1 |
| 16 | 2 | 1 | 6 | 1 |

### <Preparation of Silica Fine Particle 1>

The method put and mixed 687.9 g of methanol, 42.0 g of pure water, and 47.1 g of 28 percent by mass of aqueous ammonia in a glass reactor of 3 L equipped with an agitator, a dripping funnel, and a thermometer. The method adjusted the temperature of the obtained solution to 35° C., and, while performing agitation, started simultaneously adding 1100.0 g (7.23 mol) of tetramethoxysilane and 395.2 g of 5.4 percent by mass of aqueous ammonia. The method dripped tetramethoxysilane over 5 hours, and dripped aqueous ammonia over 4 hours.

After the end of dripping, the method further continued agitation for 0.2 hour, performed hydrolysis, and thus obtained a methanol-water dispersion liquid of hydrophilic and spherical sol-gel silica fine particles.

Next, the method mounted an ester adapter and a cooling pipe to the glass reactor, heated the above-mentioned dispersion liquid to 65° C., and thus distilled away methanol. After that, the method added the same amount of pure water as that of the distilled-away methanol. The method dried such a dispersion liquid at 80° C. under reduced pressure. The method heated the obtained silica fine particles for 10 minutes at 400° C. in a constant temperature tank. The method performed crushing of the obtained silica fine particles (unprocessed silica) by a pulverizer (manufactured by Hosokawa Micron Corporation).

After that, the method loaded 50 g of silica fine particles into a polytetrafluoroethylene inner cylinder type stainless-steel autoclave with an internal volume of 1,000 mL. After substituting nitrogen gas for the inside of the autoclave, while rotating agitating blades incorporated in the autoclave at 400 rpm, the method nebulized 0.5 g of hexamethyldisilazane and 0.1 g of water by a two-fluid nozzle and evenly sprayed the nebulized ones to the silica fine particles. After performing agitation for 30 minutes, the method hermetically sealed the autoclave and heated the autoclave for 2 hours at 200° C.

Next, the method depressurized the inside of the system while performing heating, performed deammoniation, and thus obtained a silica fine particle 1. The number average particle diameter of a primary particle of the obtained silica fine particle 1 was 100 nm.

### <Preparation of Silica Fine Particles 2 to 6>

The method obtained silica fine particles 2 to 6 by performing similar operations except that, in the preparation of the silica fine particle 1, 28 percent by mass of aqueous ammonia was set to numbers of parts shown in Table 3 and the dripping time of tetramethoxysilane and the agitation duration time after the end of such dripping were changed to conditions shown in Table 3. The number average particle diameter, SF-1, and SF-2 of a primary particle of each of the obtained silica fine particles 2 to 6 are shown in Table 3.

TABLE 3

| | Production process | | | | | |
|---|---|---|---|---|---|---|
| | 28 percent by | | | Physical property | | |
| | mass of aqueous | Dripping | Agitation | Particle | SF- | SF- |
| | ammonia | time | duration time | diameter | 1 | 2 |
| Silica fine | 47.0 g | 5.0 hours | 0.2 hours | 100 nm | 110 | 115 |
| particle 1 | | | | | | |
| Silica fine | 65.0 g | 5.0 hours | 0.2 hours | 150 nm | 113 | 118 |
| particle 2 | | | | | | |
| Silica fine | 36.0 g | 4.5 hours | 0.0 hours | 50 nm | 107 | 103 |
| particle 3 | | | | | | |
| Silica fine | 115.0 g | 5.0 hours | 0.2 hours | 300 nm | 117 | 126 |
| particle 4 | | | | | | |
| Silica fine | 33.0 g | 5.0 hours | 0.2 hours | 40 nm | 105 | 101 |
| particle 5 | | | | | | |
| Silica fine | 130.0 g | 5.0 hours | 0.2 hours | 350 nm | 120 | 130 |
| particle 6 | | | | | | |

### <Production Example for Monomer Dispersion Liquid 1 Having Silica Fine Particle and Binding Component>

The method dispersed 70 parts of styrene, 20 parts of methacryloxypropyltrimethoxysilane, 10 parts of butyl acrylate, and 100 parts of silica fine particles 1 with use of a homogenizer (ULTRA-TURRAX T50, manufactured by IKA Works GmbH & Co. KG), adjusted the temperature inside the container to 25° C., performed agitation for 1 hour, and thus obtained a monomer dispersion liquid 1 having silica and a binding component.

### <Production Example for Monomer Dispersion Liquids 2 to 14 Each Having Silica Fine Particle and Binding Component>

The method produced monomer dispersion liquids 2 to 14 each having silica and a binding component by performing similar operations except that numbers of parts and types of materials in the preparation of the monomer dispersion liquid 1 having a silica fine particle and a binding component were changed as shown in Table 4.

TABLE 4

| | Binding component | | | | |
|---|---|---|---|---|---|
| Monomer | | Number | | Number | |
| dispersion | | of parts | | of parts | |
| liquid | Monomer | added | Monomer | added | |
| No. | A | [parts] | B | [parts] | |
| 1 | St | 70 | Me | 20 | |
| 2 | St | 70 | Me | 20 | |
| 3 | St | 70 | Me | 30 | |
| 4 | St | 70 | Me | 30 | |
| 5 | St | 70 | Me | 30 | |
| 6 | St | 70 | Me | 20 | |
| 7 | St | 70 | Me | 30 | |
| 8 | St | 70 | Me | 30 | |
| 9 | St | 70 | Me | 20 | |
| 10 | St | 70 | Me | 20 | |
| 11 | St | 70 | Me | 30 | |
| 12 | St | 70 | Me | 20 | |
| 13 | St | 70 | Me | 10 | |
| 14 | St | 70 | Me | 20 | |
| | Binding component | | Silica fine particle | | |
| Monomer | | Number | | | Number |
| dispersion | | of parts | | Particle | of parts |
| liquid | Monomer | added | | diameter | added |
| No. | C | [parts] | No. | [nm] | [parts] |
| 1 | Bu | 10 | 1 | 100 | 100 |
| 2 | Bu | 10 | 1 | 100 | 100 |
| 3 | — | 0 | 2 | 150 | 100 |
| 4 | — | 0 | 1 | 100 | 100 |
| 5 | — | 0 | 3 | 50 | 100 |
| 6 | Bu | 10 | 1 | 100 | 100 |
| 7 | — | 0 | 1 | 100 | 100 |
| 8 | — | 0 | 1 | 100 | 100 |
| 9 | Bu | 10 | 2 | 150 | 100 |
| 10 | Bu | 10 | 1 | 100 | 100 |
| 11 | — | 0 | 2 | 150 | 100 |
| 12 | Bu | 10 | 2 | 150 | 100 |
| 13 | Bu | 20 | 1 | 100 | 100 |
| 14 | Bu | 10 | 4 | 300 | 100 |

* St: styrene; Me: methacryloxypropyltrimethoxysilane
* Bu: butyl acrylate

### <Production of Hydrotalcite Particle>

The method prepared a mixed aqueous solution (liquid A) of 1.03 mol per L of magnesium chloride and 0.239 mol per L of aluminum sulfate, 0.753 mol per L of a sodium carbonate aqueous solution (liquid B), and 3.39 mol per L of aqueous sodium hydroxide (liquid C).

Next, the method injected and added the liquid A, the liquid B, and the liquid C to a reaction tank via a metering pump at such a flow rate that the capacity ratio of the liquid A and the liquid B became 4.5:1, kept the pH value of the reaction solution at in the range of 9.3 to 9.6 by the liquid C, and generated a precipitate at a reaction temperature of 40° C. After performing filtration and washing, the method re-emulsified the precipitate with deionized water, and thus obtained a hydrotalcite slurry serving as a raw material. Hydrotalcite included in the obtained hydrotalcite slurry was in the concentration of 5.6 percent by mass. After that, the method performed filtration by a membrane filter with a pore diameter of 0.5 μm, and performed washing with deionized water. The method vacuum-dried the obtained hydrotalcite at 40° C. overnight, and then performed crushing processing. The number average particle diameter of the obtained hydrotalcite was 400 nm.

Next, production examples of the toner are described.

### <Production of Toner 1>

The method added 3.0 parts of the monomer dispersion liquid 1 obtained by the above-described method and 0.005 parts of potassium peroxodisulfate to 100 parts of the toner core particle dispersion liquid 1, adjusted the temperature inside the container to 90° C., performed agitation for 2 hours with the FULLZONE agitation impeller, and thus obtained a toner particle dispersion liquid 1.

The method added hydrochloric acid to the obtained toner particle dispersion liquid 1 to adjust the pH to 1.5 or less, performed agitation and leaved the toner particle dispersion liquid 1 untreated for 1 hour, then performed solid-liquid separation by a press filter, and thus obtained a toner cake. The method re-slurried the obtained toner cake with deionized water to re-convert the toner cake into a dispersion liquid, and then performed solid-liquid separation by the above-mentioned press filter. The method repeated re-slurrying and solid-liquid separation until the electrical conductivity of a filtrate became 5.0 microsiemens per centimeter (μS/cm), and, after that, finally performed solid-liquid separation to obtain a toner cake. The method dried the obtained toner cake, further performed classification with use of a classifier, and thus obtained a toner particle 1. The weight-average particle diameter of the toner particle 1 was 7.0 μm.

The method put, as an eternal additive,
0.7 parts of fumed silica fine particles subjected to hydrophobizing processing with dimethyl silicone oil (20 percent by mass) (number average particle diameter of a primary particle: 10 nm, and Brunauer-Emmett-Teller (BET) specific surface area: 170 square meters per gram (m²/g)),
0.5 parts of silica fine particles 1 as spherical silica particles, and
0.1 parts of hydrotalcite particles, as well as 100 parts of toner particles 1, into an FM mixer (Henschel mixer) (FM10C Type, manufactured by Nippon Coke & Engineering Co., Ltd.) in which water at 7° C. was passed into a jacket). After the water temperature in the jacket became stable at 7° C.±1° C., the method performed mixing for 5 minutes at a circumferential velocity of 38 meters per second (m/sec) of a rotary impeller, and thus obtained a toner mixture 1.

At that time, the method appropriately adjusted the amount of passing water in the jacket in such a way as to cause the temperature in the tank of the FM mixer not to exceed 25° C. The method sieved the obtained toner mixture 1 by a mesh with an opening size of 75 μm, and thus obtained a toner 1.

The physical property of the obtained toner 1 is shown in Table 6.

### <Production of Toners 2 to 9 and Comparative Toners 1 to 7>

The method produced toners 2 to 9 and comparative toners 1 to 7 by performing similar operations except that the types of materials and production conditions in the production of the toner 1 were changed as shown in Table 5-1 and Table 5-2.

The physical properties of the obtained toners 2 to 9 and comparative toners 1 to 7 are shown in Table 6.

TABLE 5-1

| | Toner core particle | | Monomer | | |
|---|---|---|---|---|---|
| | dispersion liquid | | dispersion liquid | | |
| | | Number of | | Number of | Potassium |
| | | parts added | | parts added | peroxodisulfate |
| Toner | No. | [parts] | No. | [parts] | [parts] |
| Toner | 1 | 100 | 1 | 1.5 | 0.005 |
| 1 | | | | | |
| Toner | 2 | 100 | 2 | 1.5 | 0.005 |
| 2 | | | | | |
| Toner | 3 | 100 | 3 | 2.0 | 0.005 |
| 3 | | | | | |
| Toner | 4 | 100 | 4 | 1.5 | 0.005 |
| 4 | | | | | |
| Toner | 5 | 100 | 5 | 3.0 | 0.005 |
| 5 | | | | | |
| Toner | 6 | 100 | 6 | 0.4 | 0.005 |
| 6 | | | | | |
| Toner | 7 | 100 | 7 | 2.7 | 0.005 |
| 7 | | | | | |
| Toner | 8 | 100 | 8 | 0.2 | 0.005 |
| 8 | | | | | |
| Toner | 9 | 100 | 9 | 2.1 | 0.005 |
| 9 | | | | | |
| Comparative | 10 | 100 | 10 | 1.5 | 0.005 |
| toner 1 | | | | | |
| Comparative | 11 | 100 | 11 | 0.3 | 0.005 |
| toner 2 | | | | | |
| Comparative | 12 | 100 | 12 | 7.2 | 0.005 |
| toner 3 | | | | | |
| Comparative | 13 | 100 | 13 | 1.2 | 0.005 |
| toner 4 | | | | | |
| Comparative | 14 | 100 | 14 | 3.8 | 0.005 |
| toner 5 | | | | | |
| Comparative | 15 | 100 | — | — | — |
| toner 6 | | | | | |
| Comparative | 16 | 100 | — | — | — |
| toner 7 | | | | | |

TABLE 5-2

| | External | | External | | External | |
|---|---|---|---|---|---|---|
| | additive 1 | | additive 2 | | additive 3 | |
| | | Number | | Number | | Number |
| | | of parts | | of parts | | of parts |
| | | added | | added | | added |
| Toner | Type | [parts] | Type | [parts] | Type | [parts] |
| Toner | fumed | 0.7 | silica | 0.5 | hydro- | 0.1 |
| 1 | silica | | fine | | talcite | |
| | | | particle | | | |
| | | | 1 | | | |
| Toner | fumed | 0.7 | silica | 0.5 | — | — |
| 2 | silica | | fine | | | |
| | | | particle | | | |
| | | | 1 | | | |
| Toner | fumed | 0.7 | silica | 0.5 | — | — |
| 3 | silica | | fine | | | |
| | | | particle | | | |
| | | | 2 | | | |
| Toner | fumed | 0.7 | silica | 0.5 | — | — |
| 4 | silica | | fine | | | |
| | | | particle | | | |
| | | | 3 | | | |
| Toner | fumed | 0.7 | silica | 0.5 | — | — |
| 5 | silica | | fine | | | |
| | | | particle | | | |
| | | | 4 | | | |
| Toner | fumed | 0.7 | silica | 0.5 | — | — |
| 6 | silica | | fine | | | |
| | | | particle | | | |
| | | | 5 | | | |
| Toner | fumed | 0.7 | silica | 0.5 | — | — |
| 7 | silica | | fine | | | |
| | | | particle | | | |
| | | | 6 | | | |
| Toner | fumed | 0.7 | — | — | — | — |
| 8 | silica | | | | | |
| Toner | fumed | 0.7 | — | — | — | — |
| 9 | silica | | | | | |
| Comparative | fumed | 0.7 | — | — | — | — |
| toner 1 | silica | | | | | |
| Comparative | fumed | 0.7 | — | — | — | — |
| toner 2 | silica | | | | | |
| Comparative | fumed | 0.7 | — | — | — | — |
| toner 3 | silica | | | | | |
| Comparative | fumed | 0.7 | — | — | — | — |
| toner 4 | silica | | | | | |
| Comparative | fumed | 0.7 | — | — | — | — |
| toner 5 | silica | | | | | |
| Comparative | fumed | 0.7 | — | — | — | — |
| toner 6 | silica | | | | | |
| Comparative | fumed | 0.7 | — | — | — | — |
| toner 7 | silica | | | | | |

TABLE 6

| | Toner | saturated | Cohesion | | |
|---|---|---|---|---|---|
| | particle | compatible | cluster | | |
| | diameter | amount | ratio | | |
| Toner | (μm) | (pats) | CI (%) | Ca/CI | Cb/CI |
| Toner | 7.0 | 40.0 | 8.0 | 0.92 | 0.21 |
| 1 | | | | | |
| Toner | 6.9 | 40.0 | 8.0 | 0.92 | 0.21 |
| 2 | | | | | |
| Toner | 6.7 | 10.0 | 6.0 | 0.95 | 0.15 |
| 3 | | | | | |
| Toner | 7.1 | 2.0 | 10.0 | 0.98 | 0.09 |
| 4 | | | | | |
| Toner | 7.3 | 2.0 | 4.0 | 1.00 | 0.05 |
| 5 | | | | | |
| Toner | 7.0 | 50.0 | 12.0 | 0.92 | 0.21 |
| 6 | | | | | |
| Toner | 6.8 | 20.0 | 2.0 | 0.97 | 0.11 |
| 7 | | | | | |
| Toner | 6.7 | 5.0 | 15.0 | 0.97 | 0.11 |
| 8 | | | | | |
| Toner | 7.1 | 5.0 | 1.0 | 0.90 | 0.25 |
| 9 | | | | | |
| Comparative | 7.3 | 0.5 | 8.0 | 0.92 | 0.21 |
| toner 1 | | | | | |
| Comparative | 6.9 | 40.0 | 0.5 | 0.95 | 0.15 |
| toner 2 | | | | | |
| Comparative | 7.0 | 4.0 | 17.0 | 0.91 | 0.23 |
| toner 3 | | | | | |
| Comparative | 6.8 | 40.0 | 8.0 | 0.87 | 0.25 |
| toner 4 | | | | | |
| Comparative | 6.7 | 4.0 | 6.0 | 0.76 | 0.53 |
| toner 5 | | | | | |
| Comparative | 7.2 | 4.0 | — | — | — |
| toner 6 | | | | | |
| Comparative | 7.0 | 6.0 | — | — | — |
| toner 7 | | | | | |
| | | Area ratio | Ratio of | | |
| | Feret | of binding | toner particles | | |
| | diameter | component | satisfying (a) | | |
| Toner | (nm) | (%) | (%) | | |
| Toner | 3000 | 17 | 88 | | |
| 1 | | | | | |
| Toner | 3000 | 19 | 84 | | |
| 2 | | | | | |
| Toner | 4000 | 14 | 79 | | |
| 3 | | | | | |
| Toner | 2000 | 18 | 85 | | |
| 4 | | | | | |
| Toner | 6000 | 35 | 92 | | |
| 5 | | | | | |
| Toner | 1000 | 18 | 87 | | |
| 6 | | | | | |
| Toner | 8000 | 19 | 83 | | |
| 7 | | | | | |
| Toner | 800 | 20 | 84 | | |
| 8 | | | | | |
| Toner | 10000 | 13 | 81 | | |
| 9 | | | | | |
| Comparative | 3000 | 20 | 84 | | |
| toner 1 | | | | | |
| Comparative | 3500 | 11 | 77 | | |
| toner 2 | | | | | |
| Comparative | 4500 | 14 | 82 | | |
| toner 3 | | | | | |
| Comparative | 2500 | 19 | 86 | | |
| toner 4 | | | | | |
| Comparative | 5500 | 7 | 73 | | |
| toner 5 | | | | | |
| Comparative | — | — | — | | |
| toner 6 | | | | | |
| Comparative | — | — | — | | |
| toner 7 | | | | | |

### Examples 1 to 9 and Comparative Examples 1 to 7

With regard to the above-mentioned obtained toners 1 to 9 and comparative toners 1 to 7, the method made the following respective evaluations.

<Evaluation of Image Unevenness after Durable Use>

The image unevenness is an image adverse effect which is caused by a member contamination, and is an image defect which is likely to be observed when a full-screen halftone image has been output. If the contamination becomes particularly worse, a void image area occurs in the image.

The method used, as an image forming apparatus, a modified machine of LBP 712Ci (manufactured by Canon Inc.). The method modified the process speed of the main body thereof to 250 mm/sec. Then, the method performed the required adjustment in such a way as to enable image formation in such a condition. Moreover, the method removed toners from black and cyan cartridges, instead, filled each of the black and cyan cartridges with 50 g of evaluative toner, and performed a durable use by performing supplementation at timing when the remaining amount fell below 20 g. The method set the toner application amount to 1.0 milligrams per square centimeter (mg/cm²).

The method evaluated image streaks occurring at the time of continuous use under the normal temperature and normal humidity environment (23° C. and 60% relative humidity (RH)). The method used, evaluative paper, XEROX 4200 Paper (grammage: 75 grams per square meter (g/m²), manufactured by XEROX Corporation).

Under the normal temperature and normal humidity environment, the method performed the intermittent continuous use, which output 2 E-letter images with a printing rate of 1% for every four minutes, for 30,000 sheets, then performed continuous outputting of a 50% halftone image and a 100% solid image onto the whole area for 5 sheets, and observed the presence or absence of an image unevenness in the fifth sheet. The method determined that the following evaluation criteria A to C corresponded to good results. Evaluation results are shown in Table 7.

### (Evaluation Criteria)

A: an image unevenness occurring in neither a halftone image nor a solid image,
B: although a minor image unevenness occurring in a halftone image, no image unevenness occurring in a solid image,
C: a minor image unevenness occurring in both a halftone image and a solid image,
D: an image unevenness accompanied by a void image occurring in only a halftone image, and
E: an image unevenness accompanied by a void image occurring in both a halftone image and a solid image.
   <Evaluation of Density Decrease after Durable Use>

The density decrease is also an image adverse effect which is caused by a member contamination, and is an image defect in which the image density becomes wholly low when a 100% solid image has been output.

The method used, as an image forming apparatus, a modified machine of LBP 712Ci (manufactured by Canon Inc.). The method modified the process speed of the main body thereof to 250 mm/sec. Then, the method performed the required adjustment in such a way as to enable image formation in such a condition. Moreover, the method removed toners from black and cyan cartridges, instead, filled each of the black and cyan cartridges with 50 g of evaluative toner, and performed a durable use by performing supplementation at timing when the remaining amount fell below 20 g. The method set the toner application amount to 1.0 mg/cm².

The method evaluated the density decrease occurring at the initial stage and after the continuous use under the normal temperature and normal humidity environment (23° C. and 60% RH).

The method used, evaluative paper, XEROX 4200 Paper (grammage: 75 g/m², manufactured by XEROX Corporation).

Under the normal temperature and normal humidity environment, the method printed a 100% solid image at the initial stage, and, after that, performed the intermittent continuous use, which output 2 E-letter images with a printing rate of 1% for every four minutes, for 30,000 sheets. After that, the method performed outputting of a 100% solid image onto the whole area, and observed the presence or absence of the density decrease.

After, in a case where an image unevenness was occurring in a whole-area solid image, avoiding such a situation, the method measured the densities of five portions, i.e., the upper left end, upper right end, center, lower left end, and lower right end, of an image with use of a Macbeth reflectance densitometer (manufactured by Macbeth Corporation), and defined the average value of the measured densities as a density.

A density difference between at the initial stage and after the durable use being smaller indicates having better evaluation. The evaluation criteria are as follows. The method determined that the following evaluation criteria A to C corresponded to good results. Evaluation results are shown in Table 7.

### (Benchmarks for Image Unevenness)

A: the density difference being 0.03 or less,
B: the density difference being 0.04 or more and 0.05 or less,
C: the density difference being 0.06 or more and 0.07 or less,
D: the density difference being 0.08 or more and 0.09 or less, and
D: the density difference being 0.10 or more.

### <Evaluation of Fixability>

The method used, as an image forming apparatus, a machine obtained by modifying a color laser printer (HP Color Laserjet CP3525dn, manufactured by HP Inc.) in such a way as to have the capability of adjusting a developing bias, and uses, as a fixing medium, Fox River Bond Paper (110 g/m²), the surface unevenness and grammage of which were relatively large. The method used a line image as an evaluative image. Since adjusting the developing bias to set the image density high makes the amount of toner on the image large and, additionally, using heavy paper with a large surface unevenness makes toner in a recessed portion of the paper or a lower layer portion of the toner layer unlikely to be fused, it is possible to strictly evaluate peeling of toner.

The evaluation procedure is as follows. First, the method left the image forming apparatus as it was overnight under a low temperature and low humidity environment (15° C. and 10% RH). If the evaluation environment is at low temperature, a fixing device is unlikely to be warmed, so that a harsh evaluation can be made. After that, the method printed a horizontal line image for which the developing bias was adjusted in such a manner the line width became 180 μm, with use of FOX RIVER BOND Paper. Additionally, after leaving the image forming apparatus as it was for 1 hour under the low temperature and low humidity environment, the method attached a tape made of polypropylene (Klebeband 19 mm×10 mm, manufactured by Tesa SE) to the horizontal line image, and slowly peeled off the tape from the horizontal line image. The method conducted visual observation and microscopic observation of the horizontal line image from which the tape had been peeled off, and made an evaluation based on the following evaluation criteria. The method determined that the following evaluation criteria A and B corresponded to good results. Evaluation results are shown in Table 7.
A: no loss being present,
B: although a loss is slightly found, the loss not being visually recognizable,
C: a loss which is even visually recognizable being found,
D: a loss which is visually recognizable being present and a portion in which the line is broken being present, and
E: a large number of breaks being present in the line.

TABLE 7

| | | | Density | | |
|---|---|---|---|---|---|
| | | | decrease | | |
| | | | | Amount | |
| | | Image | | of | |
| | Toner | unevenness | Rank | decrease | Fixability |
| Example | Toner | A | A | 0.01 | A |
| 1 | 1 | | | | |
| Example | Toner | A | A | 0.02 | A |
| 2 | 2 | | | | |
| Example | Toner | A | A | 0.03 | A |
| 3 | 3 | | | | |
| Example | Toner | A | A | 0.03 | B |
| 4 | 4 | | | | |
| Example | Toner | A | A | 0.02 | B |
| 5 | 5 | | | | |
| Example | Toner | A | A | 0.02 | A |
| 6 | 6 | | | | |
| Example | Toner | A | A | 0.02 | A |
| 7 | 7 | | | | |
| Example | Toner | B | A | 0.03 | B |
| 8 | 8 | | | | |
| Example | Toner | B | A | 0.03 | B |
| 9 | 9 | | | | |
| Comparative | Comparative | B | A | 0.03 | C |
| example | toner 1 | | | | |
| 1 | | | | | |
| Comparative | Comparative | E | C | 0.06 | A |
| example | toner 2 | | | | |
| 2 | | | | | |
| Comparative | Comparative | C | E | 0.11 | B |
| example | toner 3 | | | | |
| 3 | | | | | |
| Comparative | Comparative | C | D | 0.08 | A |
| example | toner 4 | | | | |
| 4 | | | | | |
| Comparative | Comparative | D | E | 0.12 | B |
| example | toner 5 | | | | |
| 5 | | | | | |
| Comparative | Comparative | E | C | 0.07 | B |
| example | toner 6 | | | | |
| 6 | | | | | |
| Comparative | Comparative | E | C | 0.07 | B |
| example | toner 7 | | | | |
| 7 | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203616 filed Dec. 1, 2023, which is hereby incorporated by reference herein in its entirety.

What is claimed is:

1. A toner comprising:
a toner particle,
wherein the toner particle contains a binding resin and an ester wax,
wherein 2.0 parts by mass or more of the ester wax is compatible with 100.0 parts by mass of the binding resin at 100° C.,
wherein, on a surface of the toner particle, a cohesion cluster containing a silica fine particle and a binding component is present,
wherein, when a ratio by number of toner particles each having the cohesion cluster is denoted by CI (percent by number), the CI is 1 percent by number or more and 15 percent by number or less, and
wherein, when a ratio by number of toner particles each having the cohesion cluster in a toner subjected to processing under the following ultrasound condition A is denoted by Ca (percent by number) and a ratio by number of toner particles each having the cohesion cluster in a toner subjected to processing under the following ultrasound condition B is denoted by Cb (percent by number), the CI, the Ca, and the Cb satisfy formulae (1) and (2):
ultrasound condition A: an output frequency of 30 kilohertz (kHz), an output capacity of 0.75 watt (W), and an irradiation time of 300 seconds(s), and
ultrasound condition B: an output frequency of 30 kHz, an output capacity of 30 W, and an irradiation time of 300 s,
$$0.9 \leq Ca / CI \leq 1. , and \qquad ( 1 )$$
$$0.05 \leq Cb / CI \leq 0 \text{.25} . \qquad ( 2 )$$

2. The toner according to claim 1, wherein the binding resin is a resin containing a styrene acrylic copolymer.

3. The toner according to claim 1, wherein the binding resin is a resin containing a polyester part.

4. The toner according to claim 1, wherein an arithmetic mean value Ag of Feret diameters of the cohesion cluster is 1,000 nanometers (nm) or more and 8,000 nm or less.

5. The toner according to claim 1, wherein the toner further comprises an external additive, and the external additive includes a spherical silica particle a number average particle diameter of a primary particle of which is 50 nanometers (nm) or more and 300 nm or less.

6. The toner according to claim 5, wherein the external additive further includes a hydrotalcite particle.

7. The toner according to claim 1, wherein the ester wax is a diester wax.

8. The toner according to claim 7, wherein the diester wax is an ester compound of a diol with a carbon number of 2 or more and 6 or less and a monocarboxylic acid with a carbon number of 14 or more and 22 or less.
